(19) United States
(12) Patent Application Publication
(10) Pub. No.: US 2022/0137193 A1
(43) Pub. Date: May 5, 2022

(54) MEASUREMENT APPARATUS, RANGING APPARATUS, AND MEASUREMENT METHOD

(71) Applicant: SONY SEMICONDUCTOR SOLUTIONS CORPORATION, KANAGAWA (JP)

(72) Inventors: MITSUHARU OHKI, KANAGAWA (JP); MASAHIRO WATANABE, KANAGAWA (JP); KENICHI TAYU, KANAGAWA (JP); TOMOHIRO MATSUKAWA, KANAGAWA (JP); KEITAROU AMAGAWA, KANAGAWA (JP); KUMIKO MAHARA, KANAGAWA (JP); KENSEI JO, KANAGAWA (JP)

(21) Appl. No.: 17/431,615

(22) PCT Filed: Feb. 18, 2020
(86) PCT No.: PCT/JP2020/006378

§ 371 Date: Aug. 17, 2021

(30) Foreign Application Priority Data
Feb. 27, 2019 (JP) 2019-034683

(51) Int. Cl. G01S 7/4865; G01S 17/10; G01S 7/484

(52) U.S. Cl. CPC G01S 7/4865; G01S 7/484; G01S 17/10

(57) ABSTRACT

A measurement apparatus (1a) according to an embodiment includes: a first pixel (10); a light source (131); a control unit (150) that controls emission of light emitted from the light source by generating light emission commands that allow the light source to emit light; a first measuring unit (133_{ref}) that measures a first time period between a first light emission command timing at which the control unit generates a first light emission command out of the light emission commands and a light emission timing at which the light source emits light in accordance with the first light emission command; second measuring units (133₁, 133₂, 133₃, and . . . ) each of which measures a second time period between a second light emission command timing at which the control unit generates a second light emission command out of the light emission commands and a time at which the light is received by the first pixel; and generating units (140₁, 140₂, 140₃, and . . . ) each of which generates a histogram on the basis of the second time period measured by the second measuring unit. The generating unit generates the histogram of which a starting point is a time when the first period elapses from the second light emission command.

### FIELD

The present invention relates to a measurement apparatus, a ranging apparatus, and a measurement method.

### BACKGROUND

There is a known ranging method called a direct time of flight (ToF) technique as one of ranging techniques for measuring a distance to an object to be measured by using light. In a ranging process using the direct ToF technique, a distance to an object to be measured is obtained on the basis of a time period between an emission timing that indicates emission of light emitted by a light source and a light receiving timing at which the emitted light is reflected by the object to be measured and is received as reflected light by a light receiving element.

More specifically, a time period between the emission timing and the light receiving timing at which the light is received by the light receiving element is measured, and then, time information that indicates the measured time period is stored in a memory. This measurement is performed several times and a histogram is generated on the basis of the time information that is obtained from the measurements that have been performed several times and that is stored in the memory. The distance to the object to be measured is obtained on the basis of this histogram.

### CITATION LIST

### Patent Literature

Patent Literature 1: Japanese Laid-open Patent Publication No. 2016-176750

### SUMMARY

### Technical Problem

In a configuration that performs ranging using the dToF technique, there is a need to reduce the capacity of the memory that stores therein a plurality of pieces of time information for generating a histogram.

Accordingly, it is an object in one aspect of an embodiment of the present disclosure to provide a measurement apparatus, a ranging apparatus, and a measurement method capable of reducing the capacity of a memory that stores therein a plurality of pieces of time information for generating a histogram in a configuration in which ranging is performed by using the dToF technique.

### Solution to Problem

For solving the problem described above, a measurement apparatus according to one aspect of the present disclosure has a first pixel; a light source; a control unit that controls emission of light emitted from the light source by generating light emission commands that allow the light source to emit light; a first measuring unit that measures a first time period between a first light emission command timing at which the control unit generates a first light emission command out of the light emission commands and a light emission timing at which the light source emits light in accordance with the first light emission command; a second measuring unit that measures a second time period between a second light emission command timing at which the control unit generates a second light emission command out of the light emission commands and a time at which the light is received by the first pixel; and a generating unit that generates a histogram on the basis of the second time period that is measured by the second measuring unit, wherein the generating unit generates the histogram of which a starting point is a time when the first period elapses from the second light emission command.

### BRIEF DESCRIPTION OF DRAWINGS

FIG. 1 is a diagram schematically illustrating ranging performed by using a direct ToF technique applicable to each of embodiments.

FIG. 2 is a diagram illustrating an example of a histogram based on a clock time at which a light receiving unit receives light, which is applicable to each of the embodiments.

FIG. 3 is a block diagram illustrating a configuration of an example of an electronic device using a ranging apparatus according to each of the embodiments.

FIG. 4 is a block diagram illustrating, in further detail, a configuration of an example of a ranging apparatus applicable to each of the embodiments.

FIG. 5 is a diagram illustrating a basic configuration example of pixels applicable to each of the embodiments.

FIG. 6 is schematic diagram illustrating an example of a configuration of a device applicable to the ranging apparatus according to each of the embodiments.

FIG. 7 is a diagram more specifically illustrating an example of a configuration of a pixel array unit applicable to each of the embodiments.

FIG. 8 is a diagram schematically illustrating an example of a configuration for measuring, performed using the existing technique, a light emission timing of a light source unit.

FIG. 9 is a diagram illustrating an example of a histogram generated by using an existing technique.

FIG. 10 is a diagram schematically illustrating a ranging process according to each of the embodiments.

FIG. 11 is a flowchart schematically illustrating an example of the ranging process according to each of the embodiments.

FIG. 12 is a block diagram illustrating a configuration of an example of a ranging apparatus according to a first embodiment.

FIG. 13 is a flowchart more specifically illustrating an example of the ranging process according to the first embodiment.

FIG. 14 is a diagram illustrating an example of a histogram generated in a ranging process according to the first embodiment.

FIG. 15 is a diagram illustrating an example in which the ranging process according to the first embodiment is performed in units of frames.

FIG. 16 is a block diagram illustrating a configuration of an example of a ranging apparatus according to a second embodiment.

FIG. 17 is a flowchart more specifically illustrating an example of the ranging process according to the second embodiment.

FIG. 18 is a diagram illustrating an example of a histogram generated in the ranging process according to the second embodiment.

FIG. 19 is a diagram illustrating a use example of a ranging apparatus used in a third embodiment.

FIG. 20 is a block diagram illustrating a schematic configuration example of a vehicle control system that is an example of a movable body control system to which the technique according to the present disclosure is applicable.

FIG. 21 is a diagram illustrating an example of installation positions of an imaging unit.

### DESCRIPTION OF EMBODIMENTS

Preferred embodiments of the present disclosure will be described in detail below with reference to the accompanying drawings. Furthermore, in each of the embodiments, by assigning the same reference numerals to components having the same functional configuration, overlapping descriptions thereof will be omitted.

(Configuration Common to Each Embodiment)

The present disclosure is suitable for use in a technique for detecting a photon. Before a description of each of the embodiments according to the present disclosure, in order to facilitate understanding, a technique for performing ranging on the basis of detection of photons will be described as one of techniques that are applicable to each of the embodiments. As a ranging technique in this case, a direct time of flight (ToF) technique will be used. The direct ToF technique is a technique for performing ranging on the basis of a difference between a light emission timing and a light receiving timing of light that is emitted from a light source is reflected by an object to be measured and the obtained reflected light is received by a light receiving element.

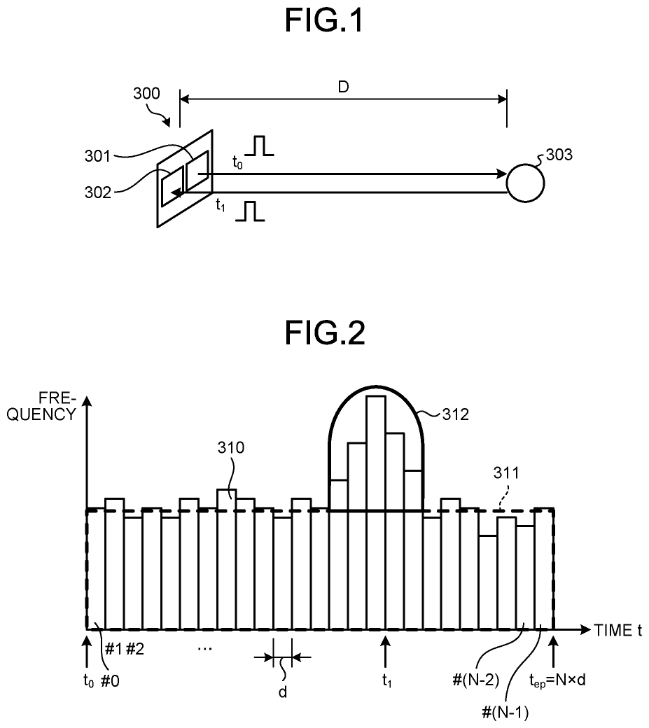

An outline of ranging performed by using the direct ToF technique will be described with reference to FIG. 1 and FIG. 2. FIG. 1 is a diagram schematically illustrating ranging performed by the direct ToF technique that is applicable to each of the embodiments. A ranging apparatus 300 includes a light source unit 301 and a light receiving unit 302. The light source unit 301 is, for example, a laser diode and is driven so as to emit pulsed laser light. The light emitted from the light source unit 301 is reflected by an object to be measured 303 and is received as reflected light by the light receiving unit 302. The light receiving unit 302 includes a light receiving element, which performs photoelectric conversion on received light to convert the received light to an electrical signal, and outputs a signal that is in accordance with the received light.

Here, it is assumed that a clock time (light emission timing) at which the light source unit 301 emits light is denoted by time t₀ and a clock time (light receiving timing) at which the light emitted from the light source unit 301 is reflected by the object to be measured 303 and is received as reflected light by the light receiving unit 302 is denoted by time t₁. If a constant c is a speed of light (2.9979×10⁸ [m/sec]), a distance D between the ranging apparatus 300 and the object to be measured 303 is calculated by Equation (1) as follows.

D=(c/2)×(t₁−t₀) (1)

The ranging apparatus 300 repeatedly performs the process described above several times. The light receiving unit 302 may include a plurality of light receiving elements and calculate each of the distances D on the basis of the respective light receiving timings at each of which the reflected light is received by each of the light receiving elements. The ranging apparatus 300 classifies time tₘ (hereinafter, referred to as light receiving time tₘ) between time t0, which is the light emission timing, and the light receiving timing, at which the light is received by the light receiving unit 302, on the basis of categories (bins), and generates a histogram.

Furthermore, the light received by the light receiving unit 302 in a period of time indicated by the light receiving time tₘ is not limited to the reflected light of the light that is emitted by the light source unit 301 and is reflected by the object to be measured. For example, ambient light that is present around the ranging apparatus 300 (the light receiving unit 302) is also received by the light receiving unit 302.

FIG. 2 is a diagram illustrating an example of a histogram based on a clock time at which the light receiving unit 302 receives the light, which is applicable to each of the embodiments. In FIG. 2, the horizontal axis indicates bins and the vertical axis indicates the frequency for each bin. The bins are sorted by classifying the light receiving time tₘ per predetermined unit time d. Specifically, a bin #0 is 0≤tₘ<d, a bin #1 is d≤tₘ<2×d, a bin #2 is 2×d≤tₘ<3×d, . . . , and a bin #(N−2) is (N−2)×d≤tₘ<(N−1)×d. If exposure time of the light receiving unit 302 is denoted by time tₑₚ, tₑₚ=N×d holds.

The ranging apparatus 300 counts the number of acquisitions of the light receiving time tₘ on the basis of the bins, obtains a frequency 310 for each bin, and generates a histogram. Here, the light receiving unit 302 also receives light other than the reflected light of the light emitted from the light source unit 301. An example of the light other than the reflected light to be targeted includes the ambient light described above. The portion indicated by a region 311 in the histogram includes an ambient light component due to the ambient light. The ambient light is light that is randomly incident into the light receiving unit 302 and causes noise with respect to the target reflected light.

In contrast, the reflected light to be targeted is the light that is received in accordance with a specific distance and appears as an active light component 312 in the histogram. The bins associated with the peak of the frequency in the active light component 312 are the bins corresponding to the distance D of the object to be measured 303. The ranging apparatus 300 acquires representative time of the subject bins (for example, the time at the center of the bins) as the time t₁ described above, so that the ranging apparatus 300 is able to calculate the distance D to the object to be measured 303 in accordance with Equation (1) described above. In this way, by using a plurality of light receiving results, it is possible to perform appropriate ranging with respect to random noise.

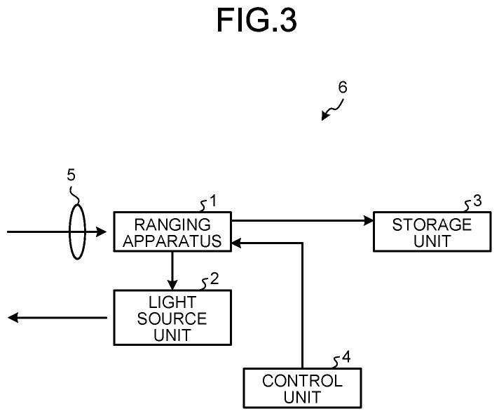

FIG. 3 is a block diagram illustrating a configuration of an example of an electronic device using the ranging apparatus according to each of the embodiments. In FIG. 3, an electronic device 6 includes a ranging apparatus 1, a light source unit 2, a storage unit 3, a control unit 4, and an optical system 5.

The light source unit 2 corresponds to the light source unit 301 described above, is a laser diode, and is driven so as to emit, for example, pulsed laser light. For the light source unit 2, a vertical-cavity surface-emitting laser (VCSEL) that emits laser light can be used as surface light source. However, the embodiment is not limited to this. The light source unit 2 may also be configured to use an array unit in which laser diodes are arranged in the form of a line and scan the laser light emitted from the laser diode array in a vertical direction relative to the line. Furthermore, the light source unit 2 may also be configured to use a laser diode as a single light source and scan the laser light emitted from the laser diode in a horizontal and vertical directions.

The ranging apparatus 1 includes a plurality of light receiving elements corresponding to the light receiving unit 302 described above. The plurality of light receiving elements forms a light receiving surface by being arranged, for example, in a two-dimensional grid manner. The optical system 5 guides the light that is incident from the outside onto the light receiving surface that is included in the ranging apparatus 1.

The control unit 4 performs overall control of the electronic device 6. For example, the control unit 4 supplies a light emission trigger that is a trigger to cause the light source unit 2 to emit light to the ranging apparatus 1. The ranging apparatus 1 allows the light source unit 2 to emit light at the timing on the basis of this light emission trigger and stores time tem that indicates the light emission timing. Furthermore, the control unit 4 sets, for example, in accordance with an instruction from the outside, a pattern at the time of ranging to the ranging apparatus 1.

The ranging apparatus 1 counts the number of acquisitions of the time information (the light receiving time tₘ), which indicates the timing at which the light is received on the light receiving surface, within a predetermined time range, and then, generates a histogram described above by obtaining the frequency for each bin. The ranging apparatus 1 further calculates the distance D to the object to be measured on the basis of the generated histogram. Information that indicates the calculated distance D is stored in the storage unit 3.

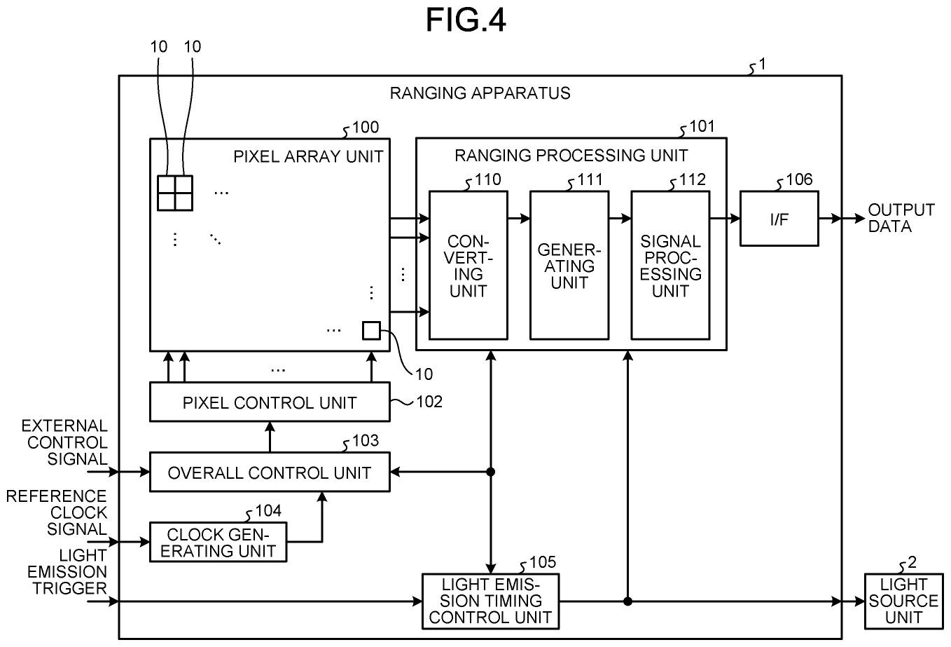

FIG. 4 is a block diagram illustrating, in further detail, a configuration of an example of the ranging apparatus 1 applicable to each of the embodiments. In FIG. 4, the ranging apparatus 1 includes a pixel array unit 100, a ranging processing unit 101, a pixel control unit 102, an overall control unit 103, a clock generating unit 104, a light emission timing control unit 105, and an interface (I/F) 106. The pixel array unit 100, the ranging processing unit 101, the pixel control unit 102, the overall control unit 103, the clock generating unit 104, the light emission timing control unit 105, and the I/F 106 can be arranged on a single semiconductor chip.

However, the configuration is not limited to this. The ranging apparatus 1 may also have a configuration in which a first semiconductor chip and a second semiconductor chip are laminated. In this case, for example, it is conceivable to use a configuration in which a part of the pixel array unit 100 (the light receiving unit, or the like) is arranged on the first semiconductor chip and the other parts of the ranging apparatus 1 are arranged on the second semiconductor chip.

In FIG. 4, the overall control unit 103 performs overall control of the ranging apparatus 1 in accordance with, for example, the program that is installed in advance. Furthermore, the overall control unit 103 may also perform control in accordance with an external control signal that is supplied from the outside. The clock generating unit 104 generates, on the basis of a reference clock signal that is supplied from the outside, one or more clock signals that are used in the ranging apparatus 1. The light emission timing control unit 105 generates a light emission control signal that indicates a light emission timing in accordance with the light emission trigger signal supplied from the outside. The light emission control signal is supplied to the light source unit 2 and is also supplied to the ranging processing unit 101.

The pixel array unit 100 includes a plurality of pixels 10, 10, and . . . each of which includes a light receiving element that is arrayed in a two-dimensional grid manner. Operations of each of the pixels 10 are controlled by the pixel control unit 102 in accordance with an instruction from the overall control unit 103. For example, the pixel control unit 102 is able to control reading of a pixel signal from each of the pixels 10 for each block that includes (p×q) pieces of pixels 10 having p pieces of pixels in a row direction and q pieces of pixels in a column direction. Furthermore, the pixel control unit 102 scans each of the pixels 10 in the row direction in units of blocks, and furthermore, scans each of the pixels 10 in the column direction, so that the pixel control unit 102 is able to read a pixel signal from each of the pixels 10. The embodiment is not limited to this and the pixel control unit 102 is able to individually control each of the pixels 10. Furthermore, the pixel control unit 102 is able to use, by defining a predetermined area of the pixel array unit 100 as a target area, the pixels 10 included in the target area as the pixels 10 that are targeted for reading the pixel signals. Furthermore, the pixel control unit 102 is able to read a pixel signal from each of the pixels 10 by collectively scanning a plurality of rows (plurality of lines) and by further scanning the scanned portion in the column direction.

Furthermore, in the following, it is assumed that scanning indicates a process of allowing the light source unit 2 to emit light and reading a signal Vpls that is associated with the light received from the pixel 10, which is continuously performed on each of the pixels 10 designated as a scanning target in a single scanning area. It is possible to perform the process of emitting light and reading the signal Vpls several times in a single scanning process.

The pixel signal that has been read from each of the pixels 10 is supplied to the ranging processing unit 101. The ranging processing unit 101 includes a converting unit 110, a generating unit 111, and a signal processing unit 112.

The pixel signals that are read from the respective pixels 10 and are output from the pixel array unit 100 are supplied to the converting unit 110. Here, the pixel signals are asynchronously read from the respective pixels 10 and are supplied to the converting unit 110. Namely, the pixel signals are read from the light receiving elements in accordance with the timing at which the light is received by the associated pixels 10 and are then output.

The converting unit 110 converts the pixel signals supplied from the pixel array unit 100 to the digital information. Namely, a pixel signal supplied from the pixel array unit 100 is output in accordance with the timing at which the light is received by the light receiving element included in the associated pixel 10 that is associated with the subject pixel signal. The converting unit 110 converts the supplied pixel signals to the time information that indicates the subject timing.

The generating unit 111 generates a histogram on the basis of the time information that indicates the time at which a pixel signal is converted by the converting unit 110. Here, the generating unit 111 counts the pieces of time information on the basis of the unit time d that is set by a setting unit 113 and generates a histogram. The histogram generating process performed by the generating unit 111 will be described in detail later.

The signal processing unit 112 performs predetermined arithmetic processing on the basis of the data on the histogram generated by the generating unit 111 and obtains, for example, distance information. The signal processing unit 112 generates curve approximation on the subject histogram on the basis of, for example, the data on the histogram generated by the generating unit 111. The signal processing unit 112 is able to detect the peak of the curved line obtained by approximating this histogram and obtain the distance D on the basis of the detected peak.

At the time of performing the curve approximation of the histogram, the signal processing unit 112 is able to perform a filter process on the curved line that is obtained by approximating the histogram. For example, the signal processing unit 112 is able to reduce a noise component by performing a low-pass filtering process on the curved line that is obtained by approximating the histogram.

The distance information obtained by the signal processing unit 112 is supplied to the interface 106. The interface 106 outputs the distance information supplied from the signal processing unit 112 to the outside as output data. For example, a mobile industry processor interface (MIPI) may be used for the interface 106.

Furthermore, in the above description, the distance information obtained by the signal processing unit 112 is output to the outside via the interface 106; however, the embodiment is not limited to this example. Namely, histogram data that is the data on the histogram generated by the generating unit 111 may also be configured to output the distance information to the outside from the interface 106. In this case, the ranging condition information that is set by the setting unit 113 may omit information that indicates a filter coefficient. The histogram data that is output from the interface 106 is supplied to, for example, an externally provided information processing apparatus and is then appropriately processed.

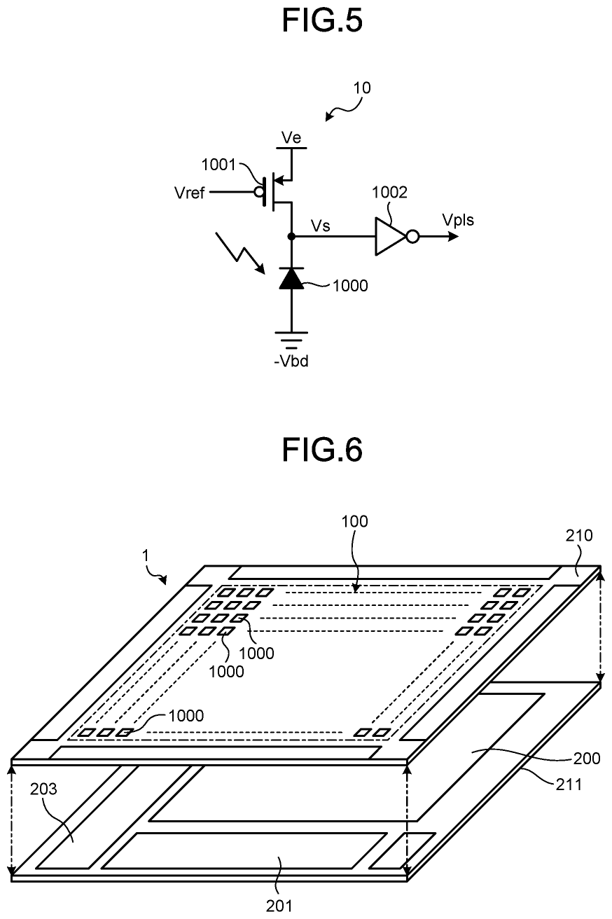

FIG. 5 is a diagram illustrating a basic configuration example of the pixel 10 applicable to each of the embodiment. In FIG. 5, the pixel 10 includes a light receiving element 1000, a transistor 1001 that is a p-channel MOS transistor, and an inverter 1002.

The light receiving element 1000 converts the incident light to an electrical signal by performing photoelectric conversion. In each of the embodiments, the light receiving element 1000 converts the incident photon to the electrical signal by performing photoelectric conversion, and then, outputs a pulse that is in accordance with the incident photon. In each of the embodiments, as the light receiving element 1000, a single-photon avalanche diode is used. Hereinafter, the single-photon avalanche diode is referred to as a single photon avalanche diode (SPAD). The SPAD exhibits a characteristic in which, if a large negative voltage that generates avalanche multiplication is applied to a cathode, electrons that are generated in accordance with a single incident photon generates avalanche multiplication and thus a large electric current flows. By using the characteristic of the SPAD, it is possible to detect a single incident photon with a high degree of sensitivity.

In FIG. 5, the light receiving element 1000 that is the SPAD has a configuration in which a cathode is connected to a drain of the transistor 1001 and an anode is connected to a voltage source of a negative voltage (−Vbd) associated with a breakdown voltage of the light receiving element 1000. The source of the transistor 1001 is connected to a voltage Ve. A reference voltage Vref is input to the gate of the transistor 1001. The transistor 1001 is an electric current source that outputs, from the drain, the voltage Ve and the electric current that is in accordance with the reference voltage Vref. With this configuration, a reverse bias is applied to the light receiving element 1000. Furthermore, a photo-electric current flows in the direction from the cathode to the anode of the light receiving element 1000.

More specifically, in the light receiving element 1000, if a photon is incident in a charged state due to an electric potential (−Vdb) after a voltage (−Vbd) is applied to an anode, avalanche multiplication is started, so that an electric current flows in the direction from the cathode toward the anode and a voltage drop is accordingly generated in the light receiving element 1000. If a voltage between the anode and the cathode of the light receiving element 1000 drops to the voltage (−Vbd) due to this voltage drop, avalanche multiplication is stopped (quenching operation). After that, the light receiving element 1000 is charged by the electric current (recharge electric current) that is output from the transistor 1001 that is the electric current source, and then, the state of the light receiving element 1000 returns to the state in which the photon is not yet incident (recharge operation).

A voltage Vs acquired from the connection point between the drain of the transistor 1001 and the cathode of the light receiving element 1000 is input to the inverter 1002. The inverter 1002 performs, for example, threshold judgement on the signal Vpls, which is to be output, with respect to the input voltage Vs, and then, inverts the signal Vpls every time the subject voltage Vs exceeds a threshold voltage Vth in the positive direction or the negative direction.

More specifically, in a voltage drop due to avalanche multiplication in accordance with incidence of the photon onto the light receiving element 1000, the inverter 1002 inverts the signal Vpls at a first timing at which the voltage Vs crosses the threshold voltage Vth. Then, the light receiving element 1000 is charged by the recharge operation, and thus, the voltage Vs is increased. The inverter 1002 again inverts the signal Vpls at a second timing at which the increasing voltage Vs crosses the threshold voltage Vth. The width of the time direction between the first timing and the second timing corresponds to an output pulse that is in accordance with incidence of the photon onto the light receiving element 1000.

The output pulse corresponds to the pixel signal that is asynchronously output from the pixel array unit 100 described above with reference to FIG. 4. In FIG. 4, the converting unit 110 converts this output pulse to the time information that indicates the timing at which the subject output pulse is supplied, and then, passes the time information to the generating unit 111. The generating unit 111 generates a histogram on the basis of the time information.

FIG. 6 is a schematic diagram illustrating an example of a configuration of a device applicable to the ranging apparatus 1 according to each of the embodiments. In FIG. 6, the ranging apparatus 1 is configured such that a light receiving chip 20 and a logic chip 21, each of which is constituted of a semiconductor chip, are laminated. Furthermore, in FIG. 5, for an explanation, the light receiving chip 20 and the logic chip 21 are illustrated in a separate state.

On the light receiving chip 20, the light receiving elements 1000 included in the respective pixels 10 are arrayed in the area of the pixel array unit 100 in a two-dimensional grid manner. Furthermore, the transistor 1001 and the inverter 1002 are formed in the pixel 10 on the logic chip 21. Both ends of the light receiving element 1000 are connected between the light receiving chip 20 and the logic chip 21 via a connecting unit 1105 formed of, for example, a copper-copper connection (CCC) or the like.

The logic chip 21 is provided with a logic array unit 2000 that includes a signal processing unit that processes the signal acquired by the light receiving element 1000. It is possible to further provide, on the logic chip 21, a signal processing circuit unit 2010, which processes the signal acquired by the light receiving element 1000, and an apparatus control unit 2030, which controls an operation as the ranging apparatus 1, at a position close to the logic array unit 2000.

For example, the signal processing circuit unit 2010 is able to include the ranging processing unit 101 described above. Furthermore, the apparatus control unit 2030 is able to include the pixel control unit 102, the overall control unit 103, the clock generating unit 104, the light emission timing control unit 105, and the interface 106, which are described above.

Furthermore, the configuration on each of the light receiving chip 20 and the logic chip 21 is not limited to this. Furthermore, in addition to controlling the logic array unit 2000, it is possible to arrange the apparatus control unit 2030 at a position close to, for example, the light receiving element 1000 for the purpose of driving or controlling the other elements. In addition to the arrangement illustrated in FIG. 6, it is possible to arrange the apparatus control unit 2030 in an arbitrary area of the light receiving chip 20 and the logic chip 21 so as to have an arbitrary function.

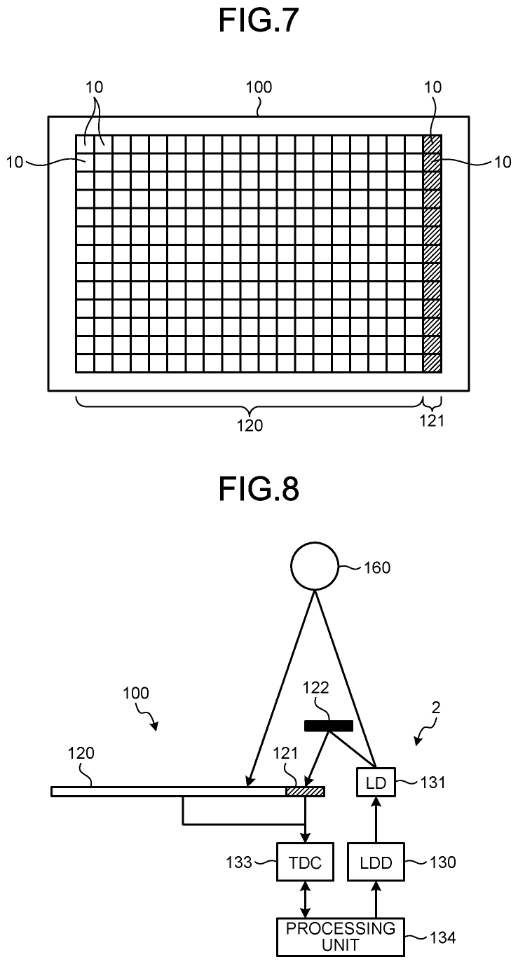

FIG. 7 is a diagram more specifically illustrating the example of the configuration of the pixel array unit 100 applicable to each of the embodiments. As described above, the pixels 10 are arranged in the pixel array unit 100 in a matrix manner. Furthermore, in FIG. 7, it is assumed that the horizontal direction is a row and the vertical direction is a column. Here, some of the pixels 10 out of the pixels 10 included in the pixel array unit 100 are used as reference pixels that are used to detect the light emission timing of the light source unit 2 (see FIG. 3 and FIG. 4). In the example illustrated in FIG. 7, the single column on the right end of the pixel array unit 100 (indicated by the column by oblique lines in FIG. 7) is defined as a reference pixel area 121 in which the pixels 10 that are used as the reference pixels are arranged.

Furthermore, the example illustrated in FIG. 7 illustrates on the assumption that the reference pixel area 121 includes the plurality of the pixels 10 that are used as the reference pixels; however, the example is not limited to this. Namely, it may also be possible to use at least one of the pixels 10 as a reference purpose pixel out of the pixels 10 that are included in the pixel array unit 100.

In the pixel array unit 100, it is assumed that the area other than the reference pixel area 121 is a measurement pixel area 120 in which each of the measurement purpose pixels 10 that are used to perform ranging measurement. In this way, the pixel array unit 100 includes the measurement pixel area 120, in which each of the measurement purpose pixels 10 is arranged, and the reference pixel area 121, in which the pixels 10 that are used as the reference pixels are arranged. Accordingly, it is possible to perform, temporally in parallel, a process that uses the pixels 10 that are the reference pixels and the process that uses each of the measurement purpose pixels 10.

(Example of Ranging Process Performed Using Existing Technique)

FIG. 8 is a diagram schematically illustrating an example of a configuration for measuring the light emission timing of the light source unit 2 performed using the existing technique. In FIG. 8, a configuration that includes a laser diode driver (LDD) 130 and a laser diode (LD) 131 corresponds to the light source unit 2 described with reference to FIG. 3 and FIG. 4. The LD 131 emits light in accordance with driving of the LDD 130. The LDD 130 drives the LD 131 in accordance with a light emission command that is supplied from a processing unit 134.

In contrast, each of the signals Vpls that are output from the respective pixels 10 included in the measurement pixel area 120 of the pixel array unit 100 is supplied to a time to digital converter (TDC) 133. Similarly, each of the signals Vpls that are output from the respective pixels 10 included in the reference pixel area 121 of the pixel array unit 100 is supplied to the TDC 133.

The TDC 133 has a function corresponding to the function of the converting unit 110 described with reference to FIG. 4, counts the clock time at which the signal Vpls is supplied, and converts the counted clock time to the clock time information that indicates the counted clock time by using a digital value. For example, the TDC 133 includes a counter that starts a count of time. The counter starts a count in synchronization with an output of the light emission command with respect to the LDD 130 sent by the processing unit 134 and stops the count in accordance with an inversion timing of the signal Vpls that is supplied from the pixel 10. Hereinafter, “the TDC 133 stops the count in accordance with the inversion timing of the signal Vpls that is supplied from the pixel 10” is referred to as “the TDC 133 stops the count in accordance with the signal Vpls” unless otherwise stated.

If the TDC 133 stops the count in accordance with the supplied signal Vpls, the TDC 133 passes the time t indicated by the stopped count to the processing unit 134. The processing unit 134 generates a histogram on the basis of the time t at which the signal Vpls that is output from each of the pixels 10 is converted.

Here, in the direct ToF technique, as described above by using Equation (1), ranging is performed on the basis of a difference between the time to of the light emission timing at which the LD 131 that is the light source emits light and the time t₁ of the light receiving timing at which the pixel 10 receives the light.

As described above, the LD 131 emits light by being driven by the LDD 130 in accordance with the light emission command that is output from the processing unit 134. At this time, a time lag is present in a period of time between a time point at which the LDD 130 drives the LD 131 in accordance with the light emission command and a time point at which the light emission timing at which the LD 131 actually emits light. The time lag is caused by a time constant on a path from the processing unit 134 to the LD 131, temperature of the LD 131 itself, or aged deterioration of the LD 131, and it is thus difficult to predict. Consequently, it is difficult to accurately the light emission timing on the basis of the information that can be acquired on the path from the processing unit 134 to the LD 131.

Accordingly, in the configuration illustrated in FIG. 8, a mirror 122 is arranged in an immediate vicinity of the LD 131 and light emitted from the LD 131 is reflected by the mirror 122. The reflected light that is reflected by the mirror 122 is received by the pixels 10 included in the reference pixel area 121. The TDC 133 obtains time tₓ related to each of the signals Vpls that are output in accordance with the light received from the pixels 10 included in the reference pixel area 121. The processing unit 134 measures, on the basis of the clock time information obtained by the TDC 133, the light receiving timing at which the reflected light that is reflected by the mirror 122 is received by the pixels 10.

Here, by shortening, to the max, an optical path length to the point at which the pixels 10 included in the reference pixel area 121 is irradiated with the light emitted from the LD 131 via the mirror 122, the period of time between the measured light receiving timing and the light emission timing of the LD 131 can be assumed as a zero time. Accordingly, this makes it possible to assume that the subject light receiving timing is the light emission timing of the LD 131. Consequently, the processing unit 134 is able to acquire the period of time of the time lag between a time point at which the light emission command is output and a time point at which the LD 131 emits light, and is able to detect the light emission timing of the LD 131 on the basis of the light emission command timing at which the light emission command is output.

In contrast, in the measurement pixel area 120, light that includes reflected light of light that is emitted from the LD 131 and that is reflected by an object to be measured 160 is received by each of the pixels 10 included in the measurement pixel area 120. The TDC 133 obtains clock time information on each of the signals Vpls that are output in accordance with the light received from each of the pixels 10 included in the measurement pixel area 120. The processing unit 134 generates a histogram by performing this operation several times (for example, several thousands of times to several tens of thousands of times), performs calculation on the basis of Equation (1) described above using the generated histogram, and obtains the distance D to the object to be measured 160.

At this time, the processing unit 134 is able to use the time, as the time t₀ that indicates the light emission timing in Equation (1), that is obtained by adding the time of the time lag described above to the light emission command timing.

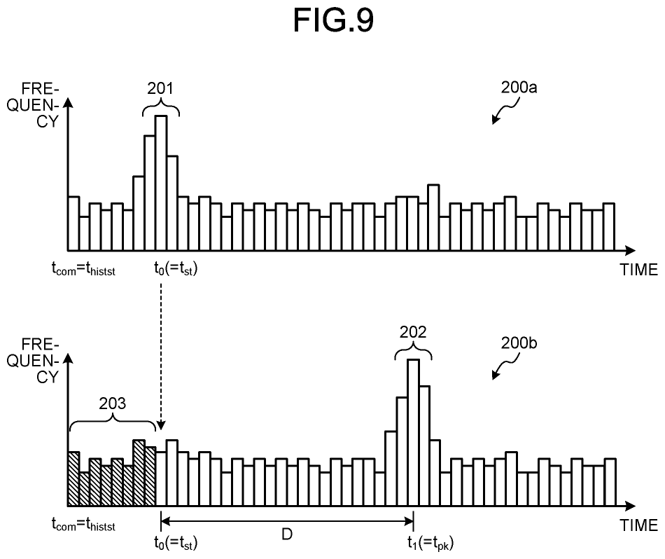

FIG. 9 is a diagram illustrating an example of the histogram generated by using the existing technique. In FIG. 9, a histogram 200a indicates an example of the histogram generated on the basis of the pixels 10 included in the reference pixel area 121. Furthermore, a histogram 200b indicates an example of the histogram generated on the basis of the pixels 10 included in the measurement pixel area 120. In each of the histograms 200a and 200b illustrated in FIG. 9, it is assumed that the vertical axis indicates the frequency, the horizontal axis indicates time, and the scale of the vertical axis and the scale of the horizontal axis are the same.

In the histogram 200a, the processing unit 134 outputs a light emission command to the LDD 130. The time t_{com} at which the light emission command is output is assumed as the light emission command timing. Furthermore, for example, at time tₕᵢₛₜₛₜ that is the same time at which the light emission command is output, the processing unit 134 starts to generate a histogram on the basis of the signal Vpls that is output from each of the pixels 10 included in the reference pixel area 121. The processing unit 134 stores time tₛₜ at which a peak 201 of the frequency is detected as the light emission timing at which the LD 131 emits light.

If the time tₛₜ that indicates the light emission timing at which the LD 131 emits light is acquired, the processing unit 134 starts to perform measurement by using the pixels 10 included in the measurement pixel area 120. The histogram 200b indicates an example of the histogram generated on the basis of the pixels 10 included in the measurement pixel area 120. The processing unit 134 outputs the light emission command to the LDD 130 at the time t_{com}=the time tₕᵢₛₜₛₜ, and also, starts to generate a histogram on the basis of the signals Vpls that are output from the pixels 10 included in the measurement pixel area 120. The processing unit 134 recognizes that time tₚₖ at which a peak 202 of the frequency is detected is the peak time of the reflected light of light that is emitted from the LD 131 and that is reflected by the object to be measured 160.

The processing unit 134 applies the pieces of time tₛₜ and tₚₖ described above to the pieces of time t₀ and t₁, respectively, in Equation (1) and calculates the distance D.

In the histogram 200b, the bins included in a range 203 that is located temporally before the time tₛₜ that indicates the light emission timing of the LD 131 are information that is irrelevant to ranging. Namely, in the range 203, each of the pixels 10 included in the measurement pixel area 120 only receives light of, for example, ambient light and the signal Vpls that is output from each of the pixels 10 does not contribute the ranging.

In this way, the information on the bins included in the range 203 is information that is useless for ranging. In contrast, the processing unit 134 generates a histogram for each of the pixels 10 included in the measurement pixel area 120. Accordingly, as the number of the pixels 10 included in the measurement pixel area 120 is increased, a larger amount of the memory capacity for storing information on the useless bins included in the range 203 is needed.

(Outline of Ranging Process According to Each Embodiment)

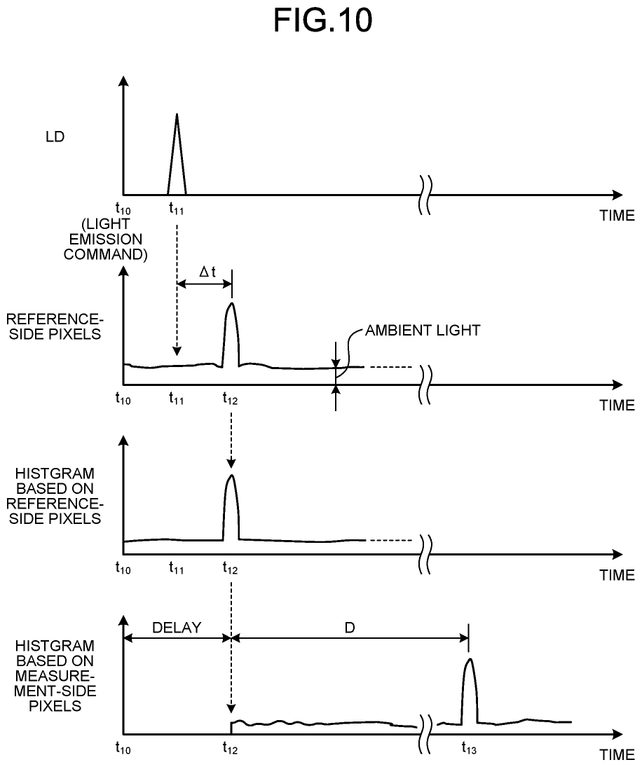

In the following, the ranging process according to each of the embodiments will be schematically described. FIG. 10 is a diagram schematically illustrating the ranging process according to each of the embodiments. FIG. 10 illustrates, from the upper part, an example of the light emission timing of the LD 131, an example of the light receiving timing of the pixels 10 included in the reference pixel area 121, an example of the histogram generated on the basis of the pixels 10 included in the reference pixel area 121, and illustrates, at the lowest part, an example of a histogram generated on the basis of the pixels 10 included in the measurement pixel area 120.

As indicated at the upper part illustrated in FIG. 10, the LD 131 emits light at time t₁₁ that corresponds to a time point that is delayed from the time t₁₀ at which the light emission command is output from the processing unit 134. The light output from the LD 131 due to this emission is reflected by the mirror 122 and the reflected light thereof is received by the pixels 10 included in the reference pixel area 121. As indicated by the second part from the top illustrated in FIG. 10, the light receiving timing is time t₁₂ that corresponds to elapse of time Δt, which is obtained in accordance with the optical path length to the point at which the pixels 10 included in the reference pixel area 121 is irradiated with the light emitted from the LD 131 via the mirror 122, after the time tn. If the optical path length is less than or equal to a predetermined length, for example, if the optical path length is extremely short with respect to the distance to the assumed object to be measured 160, the time Δt can be assumed as zero.

The pixels 10 included in the reference pixel area 121 receive ambient light in addition to the reflected light of the light emitted by the LD 131. Accordingly, as indicated by the third graph from the top illustrated in FIG. 10, the processing unit 134 generates a histogram to detect the peak and acquires the position of the detected peak as the time t₁₂ obtained on the basis of the pixels 10 in the reference pixel area 121. The period of time before the time t₁₂ (period of time from the time t₁₀ to the time t₁₂) is a period of time for which the incidence of reflected light received from the object to be measured 160 located at the position farther away from the distance between the LD 131 and the mirror 122 does not occur.

In each of the embodiments according to the present disclosure, the generation of a histogram on the basis of the light receiving timing of the pixels 10 included in the measurement pixel area 120 is started at the above described time t₁₂ as a starting point that is obtained by delaying the time t₁₀ at which the light emission command is output by the processing unit 134. As an example, as indicated by the graph at the lowest portion illustrated in FIG. 10, it is assumed that, in the histogram generated on the basis of the light receiving timing of the pixels 10 included in the measurement pixel area 120, the peak is detected at the position of time tn.

As described above, if the optical path length to the point at which the pixels 10 included in the reference pixel area 121 is irradiated with the light emitted from the LD 131 via the mirror 122 is extremely short, it is assumed that the time Δt that corresponds to a difference between the time t₁₁, which is the actual light emission timing of the LD 131 and the time t₁₂, at which the reflected light of the light that is reflected by the mirror 122 and that is emitted at the time t₁₁ is received by the pixels 10 included in the reference pixel area 121, is zero. Therefore, in the measurement performed on the basis of the pixels 10 included in the measurement pixel area 120, it is possible to calculate the distance D to the object to be measured 160 by applying the time t₁₂, as the light emission timing at which the LD 131 emits the light, to the time to in Equation (1) described above and applying the time t₁₃ to the time t₁ in Equation (1).

In the measurement performed on the basis of the pixels 10 included in the measurement pixel area 120, as an example, the time t₁₂ can be obtained as follows. Before the measurement performed on the basis of the pixels 10 included in the measurement pixel area 120, the processing unit 134 measures on the basis of the pixels 10 included in the reference pixel area 121 and acquires the time t₁₂. The processing unit 134 obtains time t₁₂₋₁₀ that is a difference between the acquired time t₁₂ and the time t₁₀ that is the light emission command timing at which the processing unit 134 outputs the light emission command, and then, stores the obtained time t₁₂₋₁₀. If the time t₁₂ is measured on the basis of the time t₁₀ as a reference (assuming that the time t₁₀ is a zero time), the time t₁₂₋₁₀ that indicates the difference is equal to the value of the time t₁₂.

Then, the processing unit 134 performs measurement on the basis of the pixels 10 in the measurement pixel area 120. At this time, the processing unit 134 obtains, on the basis of the time t₁₀ in the subject measurement and the time t₁₂₋₁₀ that is previously measured and stored, the time t₁₂ as the light emission timing at which the LD 131 has actually emitted light.

In this way, in each of the embodiments according to the present disclosure, at the time of generating a histogram that is in accordance with the light receiving timing of the pixels 10 in the measurement pixel area 120, there is no need to store information on the bins in a period of time between the time t₁₀ and the time t₁₂. Thus, according to the ranging process used in the present disclosure, it is possible to reduce the memory capacity needed to generate a histogram.

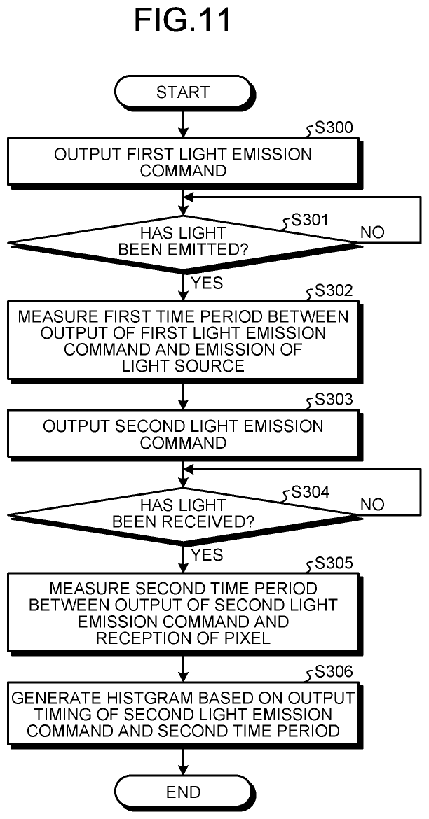

FIG. 11 is a flowchart schematically illustrating an example of the ranging process according to each of the embodiments. At Step S300, the processing unit 134 outputs the first light emission command to the LDD 130. The LDD 130 allows the LD 131 to emit light in accordance with the first light emission command. At Step S301, the processing unit 134 judges whether the light source (LD 131) emits light on the basis of the first light emission command that is output at Step S300.

Here, the processing unit 134 assumes that the light emitted from the LD 131 on the basis of the first light emission command that is output at Step S300 is reflected by the mirror 122 that is arranged in an immediate vicinity of the LD 131, and assumes that the timing at which the reflected light is received by the pixels 10 included in the reference pixel area 121 is the light emission timing at which the LD 131 emits the light. If the processing unit 134 judges that the light source does not emit light (“No” at Step S301), the processing unit 134 returns the process to Step S301.

In contrast, if the processing unit 134 judges that the light source emits light at Step S301 (“Yes” at Step S301), the processing unit 134 proceeds to the process at Step S302. At Step S302, the processing unit 134 measures, as a first time period, a period of time between the timing at which the first light emission command is output at Step S300 and a time point at which the LD 131 emits light.

At subsequent Step S303, the processing unit 134 outputs the second light emission command to the LDD 130. At subsequent Step S304, the processing unit 134 judges whether the light is received by the pixels 10 included in the measurement pixel area 120. If the processing unit 134 judges that the light is not received (“No” at Step S304), the processing unit 134 returns the process to Step S304. In contrast, if the processing unit 134 judges that the light is received by the pixels 10 included in the measurement pixel area 120 at Step S304 (“Yes” at Step S304), the processing unit 134 proceeds to the process at Step S305.

At Step S305, the processing unit 134 measures a period of time, as a second time period, between the timing at which the second light emission command is output and a time point at which the light is received by the pixels 10 in the measurement pixel area 120 at Step S304.

At subsequent Step S306, the processing unit 134 generates a histogram on the basis of the timing at which the second light emission command is output and the second time period. At this time, the processing unit 134 generates a histogram on the basis of the second time period with respect to the timing at which the second light emission command is output by using, as the starting point, the timing at which the first time period that is measured at Step S302 has elapsed.

If the histogram is generated at Step S306, a series of processes indicated by the flowchart illustrated in FIG. 11 is ended.

### First Embodiment

In the following, a first embodiment according to the present disclosure will be described. In the first embodiment, the time tₛₜ that indicates the light emission timing is detected on the basis of the signals Vpls that are output from the pixels 10 included in the reference pixel area 121. Then, the timing at which a histogram is started to be generated on the basis of the signal Vpls that is output from each of the pixels 10 included in the measurement pixel area 120 is delayed in accordance with the detected time tₛₜ. Consequently, the information on the bins that are included in the range 203 indicated by the histogram 200b illustrated in FIG. 9 is not used to generate the histogram; therefore, it is possible to reduce the capacity of the memory that stores therein the information on the histogram.

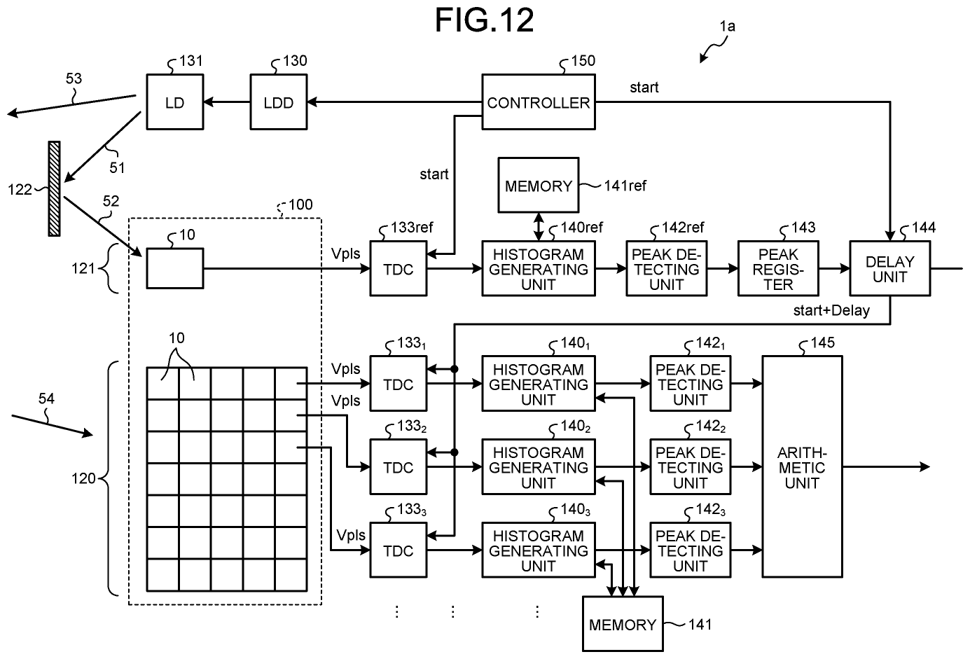

FIG. 12 is a block diagram illustrating a configuration of an example of the ranging apparatus according to the first embodiment. In FIG. 12, a ranging apparatus 1a includes the LDD 130, the LD 131, the mirror 122, the pixel array unit 100, and a controller 150 that controls overall operation of the ranging apparatus 1a. Furthermore, the pixel array unit 100 includes the measurement pixel area 120 that includes the pixels 10 as measurement pixels and the reference pixel area 121 that includes the pixels 10 as reference pixels. Furthermore, in the example illustrated in FIG. 12, it is assumed that the reference pixel area 121 includes a single piece of the pixel 10.

The controller 150 outputs a light emission command at a predetermined light emission command timing (the time t_{com}). Furthermore, the controller 150 outputs a time count start command start almost at the same time as an output of the light emission command. The LDD 130 drives the LD 131 in accordance with the light emission command that is output from the controller 150. The LD 131 emits light at the time tₛₜ in accordance with the driving, and then, emits light that is laser light. The light emitted from the LD 131 irradiates the mirror 122 as, for example, reference light 51 and is then received by the pixel 10 included in the reference pixel area 121 as reflected light 52 that is reflected by the mirror 122. Here, the mirror 122, the LD 131, and the pixel 10 that is included in the reference pixel area 121 are arranged, as described above, such that the optical path length t to the point at which the pixel 10 included in the reference pixel area 121 is irradiated with the light emitted from the LD 131 via the mirror 122 is less than or equal to a predetermined length. This means that a period of time between a time point at which the light is emitted from the LD 131 and a time point at which the pixel 10 included in the reference pixel area 121 is irradiated with the light via the mirror 122 is less than or equal to the predetermined period of time. The period of time until the pixel 10 included in the reference pixel area 121 is irradiated with the light via the mirror 122 is ideally a zero time; however, in practice, it is desirable to set the time that is just about zero time. For example, the mirror 122 is arranged in the vicinity of the LD 131 such that the distance to the LD 131 is close to a zero distance to a maximum extent.

As an example, it is conceivable to set the optical path length to a distance such that a period of time for which the light emitted from the LD 131 irradiates the pixel 10 included in the reference pixel area 121 via the mirror 122 can be assumed as zero relative to a period of time for which the subject light is reflected by the supposed object to be measured 160 and irradiates the pixels 10 included in the measurement pixel area 120.

Furthermore, the mirror 122 may also use another waveguide means as long as the light emitted from the LD 131 can be guided to the pixel 10 included in the reference pixel area 121. For example, it is conceivable to use, instead of the mirror 122, a prism or an optical fiber.

The ranging apparatus 1a further includes a reference-side configuration in which a process is performed on the pixel 10 that is included in the reference pixel area 121 and a measurement-side configuration in which a process is performed on the pixels 10 that are included in the measurement pixel area 120.

The reference-side configuration includes a TDC 133ref, a histogram generating unit 140ref, a memory 141ref, a peak detecting unit 142ref, a peak register 143, and a delay unit 144. The TDC 133ref receives the time count start command start from the controller 150. Furthermore, the TDC 133ref receives an input of the signal Vpls that is output from the pixel 10 included in the reference pixel area 121. The TDC 133ref starts to count in accordance with the time based on the time count start command start received from the controller 150, stops the count in accordance with the signal Vpls that is received from the pixel 10 included in the reference pixel area 121, and delivers the clock time information indicated by the stopped count to the histogram generating unit 140ref.

The histogram generating unit 140ref classifies, on the basis of a histogram, the clock time information delivered from the TDC 133ref, and then, increments a value of each of the bins associated with the histogram. The data on the histogram generated by the histogram generating unit 140ref is stored in the memory 141ref.

A series of processes of outputting the light emission command to the LDD 130, emitting light in accordance with the light emission command performed by the LD 131, converting the signal Vpls to the clock time information performed by the TDC 133ref, incrementing the bin associated with the histogram on the basis of the clock time information performed by the histogram generating unit 140ref is repeated a predetermined number of times (for example, several thousands of times to several tens of thousands of times), and then, the generation of the histogram performed by the histogram generating unit 140ref has been completed.

If the generation of the histogram has been completed, the peak detecting unit 142ref reads the data on the histogram from the memory 141ref and detects the peak on the basis of the read data on the histogram. A peak detecting unit 142 delivers the information associated with the position (bin) of the detected peak on the histogram to the peak register 143. The peak register 143 stores therein the information delivered from the peak detecting unit 142.

Here, the information stored in the peak register 143 is information that indicates a period of time, for the detected peak, since the time t_{com} of the light emission command timing at which the light emission command is output. Namely, the information stored in the peak register 143 is information that indicates the time tₛₜ of the light emission timing at which the LD 131 emits light in accordance with the light emission command. More accurately, the time tₛₜ corresponds to a period of time (time t₁₂₋₁₀) between a time point at which the light emission command is output (the time t₁₀) and a time point at which the reference light 51 emitted by the LD 131 due to the light emission command is reflected by the mirror 122 and the reflected light 52 is received by the pixel 10 included in the reference pixel area 121 (the time t₁₂).

The delay unit 144 reads, in accordance with the command output from the controller 150, information that indicates the time tₛₜ (hereinafter, simply referred to as the “time tₛₜ”) stored in the peak register 143.

The measurement-side configuration includes, on a one-to-one basis, TDCs 133₁, 133₂, 133₃, and . . . , histogram generating units 140₁, 140₂, 140₃, and . . . , and peak detecting units 142₁, 142₂, 142₃, and . . . associated with the respective pixels 10 included in the measurement pixel area 120 in the pixel array unit 100. For example, the TDC 133₁, the histogram generating unit 140₁, and the peak detecting unit 142₁ are associated with one of the pixels 10 included in the measurement pixel area 120.

In a similar manner, the TDC 133₂, the histogram generating unit 140₂, and the peak detecting unit 142₂; and the TDC 133₃, the histogram generating unit 140₃, and the peak detecting unit 142₃; and . . . are associated with the corresponding one of the pixels 10.

Similarly to the reference-side configuration described above, the controller 150 outputs the light emission command at a predetermined light emission command timing (the time t_{com}). Furthermore, the controller 150 outputs the time count start command start at the same time at which the light emission command is output. The LDD 130 drives the LD 131 in accordance with the light emission command that is output from the controller 150. The LD 131 emits light at the time tₛₜ in accordance with the driving, and then, ejects light that is laser light.

The light ejected from the LD 131 is ejected to the outside of the ranging apparatus 1a as, for example, measurement light 53, is reflected by, for example, the object to be measured 160, which is not illustrated, and is then received by each of the pixels 10 included in the measurement pixel area 120 as reflected light 54. In addition to the reflected light 54, ambient light is also received by each of the pixels 10 in the measurement pixel area 120.

In contrast, the time count start command start that is output from the controller 150 is supplied to the delay unit 144. If the time count start command start is supplied, the delay unit 144 reads, from the peak register 143, the time tₛₜ at which the LD 131 emits light in accordance with the light emission command. The delay unit 144 allows the time count start command start to be delayed in accordance with the time tₛₜ that is read from the peak register 143, and then, supplies the delayed time count start command start to each of the TDCs 133₁, 133₂, 133₃, and . . . .

Consequently, each of the TDCs 133₁, 133₂, 133₃, and . . . starts a count at the timing that is delayed by the time tₛₜ from the time t_{com} of the light emission command timing. Therefore, the signal Vpls that is output from each of the pixels 10 before the time tₛₜ is ignored by each of the TDCs 133₁, 133₂, 133₃, and . . . .

The operation performed in each of the histogram generating units 140₁, 140₂, 140₃, and . . . , and each of the peak detecting units 142₁, 142₂, 142₃, and . . . is substantially the same as the operation performed in the histogram generating unit 140ref and the peak detecting unit 142ref included in the reference-side configuration described above.

Namely, if a description will be given by using, as an example, the histogram generating unit 140₁ and the peak detecting unit 142₁, the histogram generating unit 140₁ classifies the clock time information delivered from the TDC 133₁ in accordance with the histogram, and then, increments a value of each of the bins associated with the histogram. The data on the histogram generated by the histogram generating unit 140₁ is stored in a memory 141. Furthermore, in the example illustrated in FIG. 12, the memory 141 is commonly used by each of the histogram generating units 140₁, 140₂, 140₃, and . . . ; however, the example is not limited to this. Each of the histogram generating units 140₁, 140₂, 140₃, and . . . may also have a memory.

A series of processes of outputting the light emission command to the LDD 130, emitting light in accordance with the light emission command performed by the LD 131, converting the signal Vpls to the clock time information performed by the TDC 133₁, incrementing each of the bins associated with the histogram on the basis of the clock time information performed by the histogram generating unit 140₁ is repeated a predetermined number of times (for example, several thousands of times to several tens of thousands of times) and the generation of the histogram performed by the histogram generating unit 140₁ has been completed.

If the generation of the histogram has been completed, the peak detecting unit 142₁ reads the data on the histogram generated by the histogram generating unit 140₁ from the memory 141 and detects the peak on the basis of the read data on the histogram.

The peak detecting unit 142₁ delivers the information that is associated with the position (bin) of the detected peak in the histogram to an arithmetic unit 145. The arithmetic unit 145 also receives a supply of the information that is associated with the position (bin) of the peak in the histogram and that is detected by the other peak detecting units 142₂, 142₃, and . . . . The arithmetic unit 145 calculates the distance D for each output of each of the pixels 10 on the basis of the information supplied from each of the peak detecting units 142₁, 142₂, 142₃, and . . . .

(Specific Example of Ranging Process According to First Embodiment)

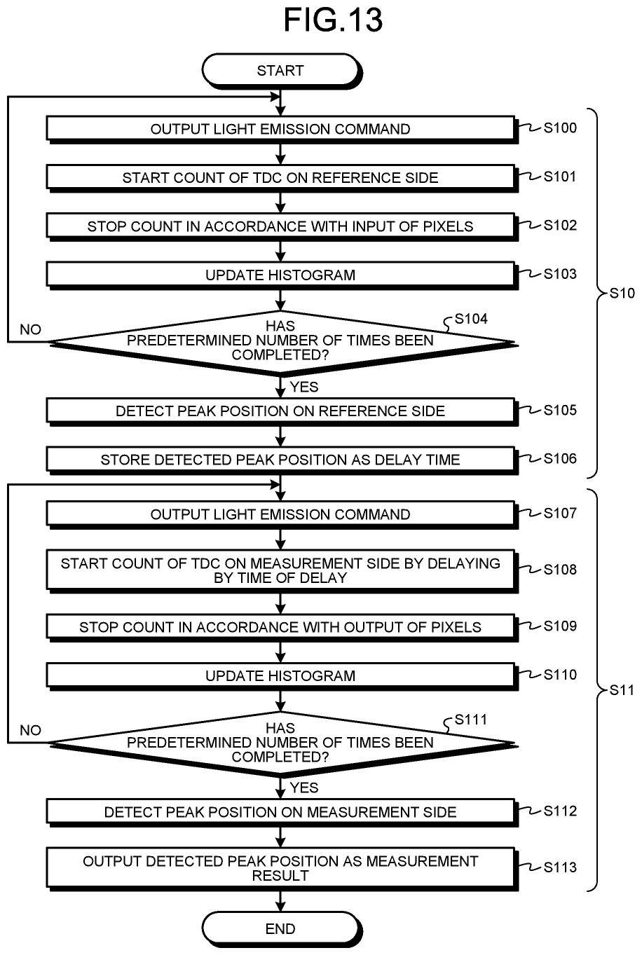

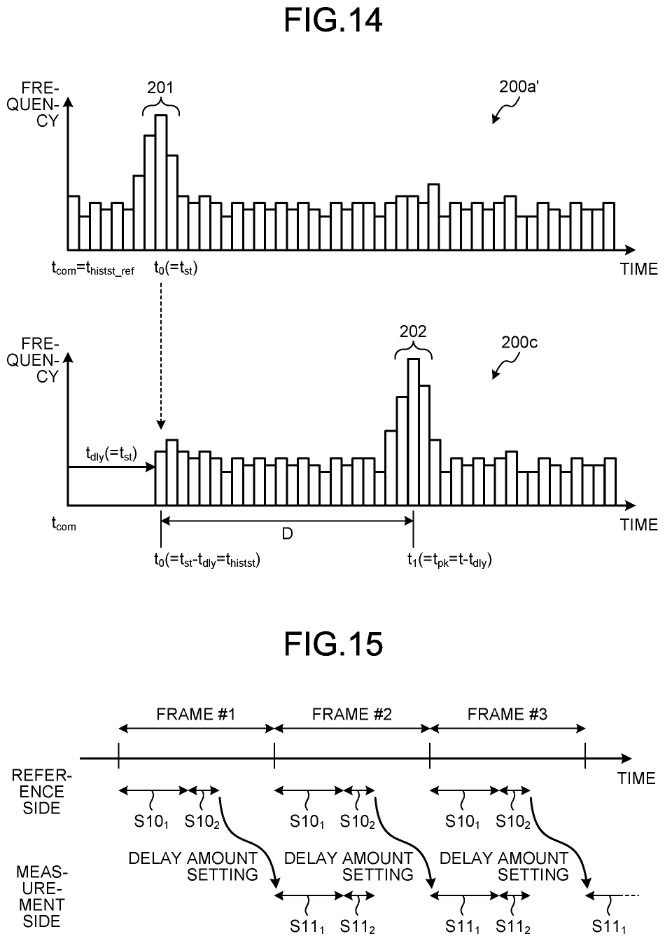

FIG. 13 is a flowchart more specifically illustrating the example of the ranging process according to the first embodiment. Furthermore, FIG. 14 is a diagram illustrating an example of the histogram generated in the ranging process according to the first embodiment. Furthermore, in FIG. 14, a histogram 200a′ indicated on the upper portion is associated with the histogram 200a that is described above with reference to FIG. 9.

In FIG. 13, the ranging process according to the first embodiment includes a process performed on the basis of the light receiving timing of the pixel 10 included in the reference pixel area 121 (Step S10) and a process performed on the basis of the light receiving timing of the pixels 10 included in the measurement pixel area 120 (Step S11). Namely, the process at Step S11 is a measurement process that is performed in order to obtain the distance D to the object to be measured 160 and the process at Step S10 is a process that is performed in order to determine a starting point of the histogram generated in the process at Step S11. In the example illustrated in FIG. 13, Step S10 includes each of the processes performed at Step S100 to Step S106 and Step S11 includes each of the processes performed at Step S107 to Step S113.

First, the process at Step S10 will be described. In Step S10, at Step S100, the controller 150 outputs the light emission command for allowing the LD 131 to emit light (the time t_{com} in FIG. 14). Furthermore, here, it is assumed that each time is time obtained by setting the time t_{com} as the starting point. The LDD 130 drives the LD 131 in accordance with the light emission command and allows the LD 131 to emit light. It is assumed that the light emission timing at which the LD 131 emits the light in accordance with this driving is defined as the time tₛₜ. At subsequent Step S101, the controller 150 outputs the time count start command start to the TDC 133ref that is associated with the pixel 10 included in the reference pixel area 121.

In the reference-side configuration, the TDC 133ref starts a count that is performed in accordance with the time according to the time count start command start supplied from the controller 150 at Step S101. In accordance with the start of the count, the generation of the histogram 200a′ is started in the histogram generating unit 140ref (the time t_{hist_st} ref in FIG. 14). Furthermore, the process at Step S101 is performed at substantially the same time as the process at Step S100. Therefore, the time t_{com}=the time t_{hist_st} ref is obtained.

The TDC 133ref stops the count in accordance with the signal Vpls that is input from the pixel 10 included in the reference pixel area 121 (Step S102). The TDC 133ref delivers the clock time information indicated by the count that is stopped at Step S103 to the histogram generating unit 140ref. The histogram generating unit 140ref increments the value of each of the bins that are associated with the time information delivered from the TDC 133ref by 1 and that are included in the histogram stored in the memory 141ref, and then, updates the histogram (Step S103).

At subsequent Step S104, the controller 150 judges whether the processes at Step S100 to Step S103 have been completed by a predetermined number of times (for example, several thousands of times to several tens of thousands of times). If the controller 150 judges that the processes are not completed (“No” at Step S104), the controller 150 returns the process to Step S100. In contrast, if the controller 150 judges that a processes at Step S100 to Step S103 have been completed by a predetermined number of times (“Yes” at Step S104), the controller 150 proceeds the process to Step S105.

At Step S105, in the reference-side configuration, the peak detecting unit 142ref detects the peak position of the frequency on the basis of the histogram generated by the histogram generating unit 140ref at the processes performed at Step S100 to Step S104. At subsequent Step S106, the peak detecting unit 142ref allows the peak register 143 to store the information that indicates the time associated with the peak position detected at Step S105 as the delay time t_{dly}. The delay time t_{dly} is associated with the time t₁₂₋₁₀ described above with reference to FIG. 10.

In the process performed at Step S10, as indicated by the histogram 200a′ illustrated in FIG. 14, the peak 201 is detected at the position of the time tₛₜ that indicates the light emission timing of the LD 131. The peak detecting unit 142ref allows the peak register 143 to store the time tₛₜ as the delay time t_{dly}.

If the process at Step S106 has been ended, the process at the Step S10 has been completed, and then, the process proceeds to Step S11. In Step S11, at Step S107, the controller 150 outputs the light emission command for allowing the LD 131 to emit light (the time t_{com} in FIG. 14). The LDD 130 drives the LD 131 in accordance with the light emission command and allows the LD 131 to emit light. In accordance with this driving, the LD 131 emits light at the time tₛₜ as the light emission timing.

At subsequent Step S108, the controller 150 outputs the time count start command start to the TDCs 133₁, 133₂, 133₃, and . . . associated with the respective pixels 10 included in the measurement pixel area 120. At this time, the controller 150 outputs the time count start command start by delaying the time t_{com} of the light emission command timing by the delay time t_{dly} stored in the peak register 143 at Step S106. The time count start command start, in which the time t_{com} is delayed by the delay time t_{dly}, is supplied to each of the TDCs 133₁, 133₂, 133₃, and . . . associated with the corresponding pixels 10 included in the measurement pixel area 120.

Furthermore, in accordance with the start of the count, in the histogram generating units TDC 140₁, 140₂, 140₃, and . . . associated with the TDCs 133₁, 133₂, 133₃, and . . . , respectively, on a one-to-one basis, the generation of each of the histograms 200c is started (the time t_{hist_st} in the histogram 200c illustrated in FIG. 14). Each of the histogram generating units TDC 140₁, 140₂, 140₃, and . . . generates the histogram 200c by setting the time t_{hist_st} as the starting point. Here, the histogram 200c is generated, on a one-to-one basis, for each of the respective pixels 10 included in the measurement pixel area 120.

Each of the TDCs 133₁, 133₂, 133₃, and . . . stops the associated counts in accordance with the associated signals Vpls that are input from the associated pixels 10 included in the measurement pixel area 120 (Step S109). Each of the TDCs 133₁, 133₂, 133₃, and . . . delivers the clock time information indicated by the count that is stopped at Step S109 to the associated histogram generating units 140₁, 140₂, 140₃, and . . . that are associated with, one to one, the TDCs 133₁, 133₂, 133₃, and . . . . Each of the histogram generating units 140₁, 140₂, 140₃, and . . . increments the value of each of the bins that are associated with the time information delivered from the respective TDCs 133₁, 133₂, 133₃, and . . . and that are associated with the respective histograms stored in the memory 141 by 1, and then, updates each of the histograms (Step S110).

At subsequent Step S111, the controller 150 judges whether the processes at Step S107 to Step S110 have been ended by a predetermined number of times (for example, several thousands of times to several tens of thousands of times). If the controller 150 judges that the process have not been ended (“No” at Step S111), the controller 150 returns the process to Step S107. In contrast, if the controller 150 judges that the processes at Step S107 to Step S110 have been ended by a predetermined number of times (“Yes” at Step S111), the controller 150 proceeds the process to Step S112.

At Step S112, each of the peak detecting units 142₁, 142₂, 142₃, and . . . detects, on the basis of each of the histograms 200c generated by the associated with histogram generating units 140₁, 140₂, 140₃, and . . . performed by the processes at Step S107 to Step S111, the time tₚₖ that is associated with the position of the peak 202 of the frequency. The time tₚₖ is a period of time between the time t_{hist_st} and a time point of the position of the peak 202 and is the time obtained by subtracting the delay time t_{dly} from the time t at the position of the peak 202 from the time t_{com}.

At subsequent Step S113, each of the peak detecting units 142₁, 142₂, 142₃, and . . . outputs each of the corresponding pieces of the time tₚₖ that is associated with, one to one, the detected peak positions as the measurement result of the ranging. Each of the pieces of the time tₚₖ that are output from the associated peak detecting units 142₁, 142₂, 142₃, and . . . is supplied to the arithmetic unit 145. The arithmetic unit 145 calculates each of the distances D associated with the respective pixels 10 included in the measurement pixel area 120 by using the time t_{hist_st} as the time t₀ represented in Equation (1) described above and using each of the pieces of the time tₚₖ as the time t₁ represented in Equation (1).

In this way, in the first embodiment, the time tₛₜ at which the LD 131 emits light is measured on the basis of the signal Vpls that is output from the pixel 10 included in the reference pixel area 121. Then, in the ranging process performed on the basis of the signal Vpls that is output from each of the pixels 10 included in the measurement pixel area 120, the generation of the histogram is started by delaying the time t_{com} by the time tₛₜ (=the delay time t_{dly}) that is measured on the basis of the output of the pixel 10 included in the reference pixel area 121. Accordingly, in the memory 141 that stores therein the data on the histogram with respect each of the pixels 10 included in the measurement pixel area 120, there is no need to store the data related to the period of time between the time t_{com} and the time tₛₜ, and it is thus possible to reduce the capacity of the memory 141.

(Example of Performing Ranging Process in Units of Frames)

In the following, an example of a case in which the ranging process according to the first embodiment is performed in units of frame will be described. FIG. 15 is a diagram illustrating an example in which the ranging process according to the first embodiment is performed in units of frames. As described above with reference to FIG. 12, the ranging apparatus 1a according to the first embodiment includes a configuration in which a histogram is generated on the basis of an output of the pixel 10 included in the reference pixel area 121 and a configuration in which each of the histograms is generated on the basis of an output of each of the pixels 10 included in the measurement pixel area 120. Accordingly, it is possible to perform the processes in each of the configurations temporally in parallel.

FIG. 15 illustrates a ranging process that is performed in units of frames at a constant cycle (for example, 1/30 [sec]). Furthermore, FIG. 15 illustrates a state in which Step S10 and Step S11 indicated by the flowchart illustrated in FIG. 13 are separately indicated as a set of Step S10₁ and Step S10₂, and a set of Step S11₁ and Step S11₂.

The process at Step S10₁ includes repetition processes performed at Step S100 to Step S104 indicated by flowchart illustrated in FIG. 13. Furthermore, the process at Step S10₂ includes the processes at Step S105 and Step S106. Namely, at Step S10₁, a histogram is generated on the basis of an output of the pixel 10 included in the reference pixel area 121; at Step S10₂, the peak is detected on the basis of the histogram that is generated at Step S10₁; and then, the delay time t_{dly} is obtained.

Similarly, the process at Step 11₁ includes repetition processes performed at Step S107 to Step S111 indicated by the flowchart illustrated in FIG. 13. Furthermore, the process at Step S11₂ includes the processes at Step S112 and Step S113. Namely, at Step 11₁, each of the histograms associated with the respective pixels 10 is generated, on the basis of each of the outputs of the respective pixels 10 included in the measurement pixel area 120, by delaying the generation start timing by the delay time t_{dly}. At Step S11₂, each of the peaks is detected on the basis of the respective histograms generated at Step 11₁, and then, the distance D is calculated for each of the outputs of the respective pixels 10.

Here, in the process on each of the frames of the frames #1, #2, #3, and . . . , the process at Step 11₁ is performed by using the delay time t_{dly} that is obtained in the immediately before frame performed at Step S10₂. More specifically, by using the delay time t_{dly} in the frame #1 obtained at Step S10₂, the process at Step 11₁ is performed in the subsequent frame #2. Furthermore, in the frame #2, the processes at Step S10₁ and Step S10₂ are performed in parallel with the processes at Step S111 and Step S11₂.

Similarly, by using the delay time t_{dly} that is obtained in the frame #2 performed at Step S10₂, the process at Step S111 is performed in the subsequent frame #3. Furthermore, in the frame #3, the processes at Step S10¹ and Step S10₂ are performed in parallel with the processes at Step S111 and Step S11₂.

In this way, in the first embodiment, in each of the frames, by using the delay time t_{dly} that is obtained in the frame immediately before, the processes at Step S11₁ and Step S11₂ are performed, and furthermore, the process at Step S10₁ and Step S10₂ for obtaining the delay time t_{dly} that is used in the subsequent frame is performed.

### Second Embodiment

In the following, a second embodiment according to the present disclosure will be described. In the second embodiment, similarly to the first embodiment described above, the time tₛₜ that indicates the light emission timing is detected on the basis of the signal Vpls that is output from the pixel 10 included in the reference pixel area 121. A histogram is generated in each of the histogram generating units 140₁, 140₂, 140₃, and . . . on the basis of the signal Vpls that is output each of the pixels 10 included in the measurement pixel area 120, by using the time obtained by subtracting the time tₛₜ from each time t that is converted by each of the TDCs 133₁, 133₂, 133₃, and . . . . Consequently, the information on the bins included in the range 203 indicated by the histogram 200b illustrated in FIG. 9 are not used to generate the histogram; therefore, it is possible to reduce the capacity of the memory that stores therein the information on the histogram.

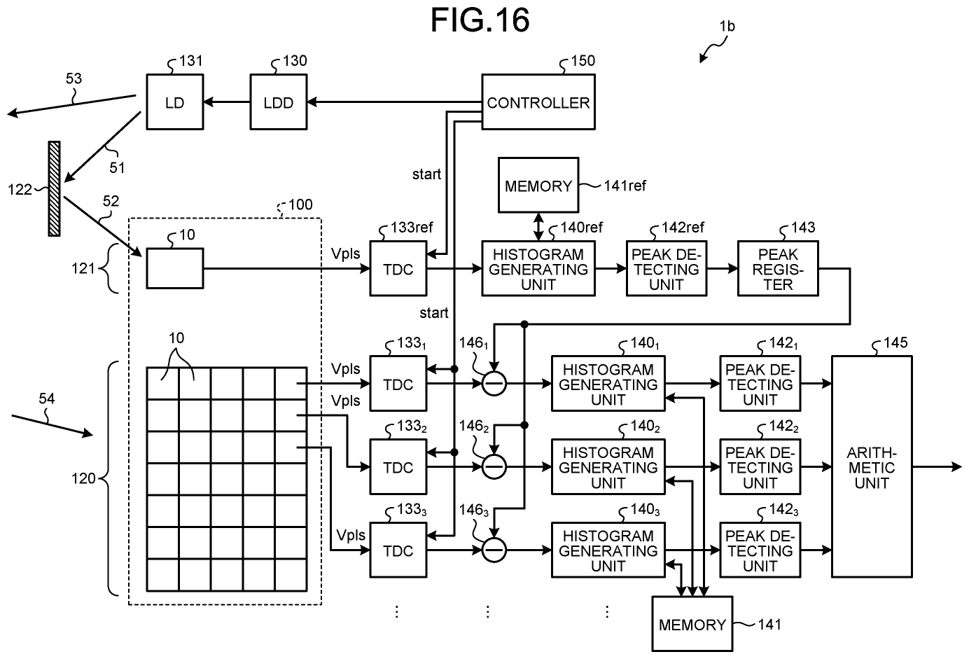

FIG. 16 is a block diagram illustrating a configuration of an example of a ranging apparatus according to the second embodiment. In FIG. 16, a ranging apparatus 1b has a configuration in which, in the reference-side configuration with respect to the pixel 10 included in the reference pixel area 121, the delay unit 144 is excluded from the reference-side configuration described above with reference to FIG. 12. Namely, in the reference-side configuration, the configuration and the operation of the TDC 133ref, the histogram generating unit 140ref, the memory 141ref, and the peak detecting unit 142ref are the same as the configuration and the operation of the TDC 133ref, the histogram generating unit 140ref, the memory 141ref, and the peak detecting unit 142ref described with reference to FIG. 12. Furthermore, in also the second embodiment, similarly to the first embodiment described above, the mirror 122, the LD 131, the pixel 10 included in the reference pixel area 121 are arranged such that the optical path length to the point at which the pixel 10 in the reference pixel area 121 is irradiated with the light emitted from the LD 131 via the mirror 122 is less than or equal to a predetermined length.

In the reference-side configuration, the TDC 133ref starts a count that is in accordance with the time based on the time count start command start received from the controller 150. The TDC 133ref stops the count in accordance with the signal Vpls that is input from the pixel 10 included in the reference pixel area 121 and delivers the clock time information indicated by the stopped count to the histogram generating unit 140ref. The histogram generating unit 140ref increments the value of each of the bins in the histogram on the basis of the clock time information that is delivered from the TDC 133ref, and then, stores the updated data on the histogram in the memory 141ref.

A series of processes of outputting the light emission command to the LDD 130, emitting light performed in accordance with the light emission command by the LD 131, converting the signal Vpls to the clock time information performed by the TDC 133ref, incrementing the bins included in the histogram on the basis of the clock time information performed by the histogram generating unit 140ref is repeated a predetermined number of times and the generation of the histogram performed by the histogram generating unit 140ref has been completed.

When the generation of the histogram has been completed, the peak detecting unit 142ref reads the data on the histogram from the memory 141ref and detects the peak on the basis of the read data on the histogram. The peak detecting unit 142 delivers the information associated with the position (bin) of the detected peak in the histogram to the peak register 143. The peak register 143 stores the information delivered from the peak detecting unit 142. Here, similarly to the case described in the first embodiment, the information stored in the peak register 143 is the time tₛₜ that indicates the light emission timing at which the LD 131 emits light and that is obtained by detecting the peak performed by the peak detecting unit 142ref.

In contrast, in the ranging apparatus 1b illustrated in FIG. 16, the measurement-side configuration with respect to each of the pixels 10 in the measurement pixel area 120, subtracter 1461, 1462, 1463, and . . . are added, to the reference-side configuration described above illustrated FIG. 12, between the TDCs 133₁, 133₂, 133₃, and . . . , and the histogram generating units 140₁, 140₂, 140₃, and . . . , respectively.

The time tₛₜ that is stored in the peak register 143 is input to each of the subtraction input ends of the associated subtracter 1461, 1462, 1463, and . . . .

For example, the TDC 133₁ inputs, to the subtracted input end of the subtracter 1461, the clock time information (defined as the time t₁₀₀) that is obtained by converting the signal Vpls supplied from the associated pixel 10 included in the measurement pixel area 120. The subtracter 1461 subtracts the time tₛₜ, which is input to the subtraction input end, from the time t, which is input to the subtracted input end, and then, outputs the time (t₁₁₀−tₛₜ) that is the subtraction result. The time (t₁₁₀−tₛₜ) is supplied to the histogram generating unit 140₁.

The operation of the TDC 133₁ is the same in the other TDCs 133₂, 133₃, and . . . that are associated with the respective pixels 10 included in the measurement pixel area 120.

Namely, for example, the TDC 133₂ and 133₃ inputs, to the subtracted input end of each of the subtracter 1462 and 1463, the clock time information (defined as the time t₁₀₁ and t₁₀₂) obtained by converting each of the signals Vpls supplied from the associated pixels 10 included in the measurement pixel area 120. Each of the subtracter 1462 and 1463 subtracts the time tₛₜ, which is input to the subtraction input end, from the time tin and t₁₀₂, which are input to the respective subtracted input ends, and then, outputs the time (t₁₀₁−tₛₜ) and the time (t₁₀₂−tₛₜ) that are the respective subtraction results. The time (t₁₀₁−tₛₜ) and the time (t₁₀₂−tₛₜ are supplied to the histogram generating units 140₂ and 140₃, respectively.

The operation of each of the histogram generating units 140₁, 140₂, 140₃, and . . . , and each of the peak detecting units 142₁, 142₂, 142₃, and . . . is the same as the operation of each of the histogram generating units 140₁, 140₂, 140₃, and . . . , and each of the peak detecting units 142₁, 142₂, 142₃, and . . . described above with reference to FIG. 12. However, in the second embodiment, each of the histogram generating units 140₁, 140₂, 140₃, and . . . , and each of the peak detecting units 142₁, 142₂, 142₃, and . . . generates a histogram and detects the peak in the histogram on the basis of the time (t₁₀₀−tₛₜ), the time (t₁₀₁−tₛₜ), the time (t₁₀₂−tₛₜ), and . . . that are output from the respective subtracter 1461, 1462, 1463, and . . . .

Each of the peak detecting units 142₁, 142₂, 142₃, and . . . delivers the information that is associated with the position (bin) of the detected peak of the histogram to the arithmetic unit 145. The arithmetic unit 145 calculates the distance D for each output of the corresponding pixels 10 on the basis of the information supplied from each of the peak detecting units 142₁, 142₂, 142₃, and . . . .

(More Specific Example of Ranging Process According to Second Embodiment)

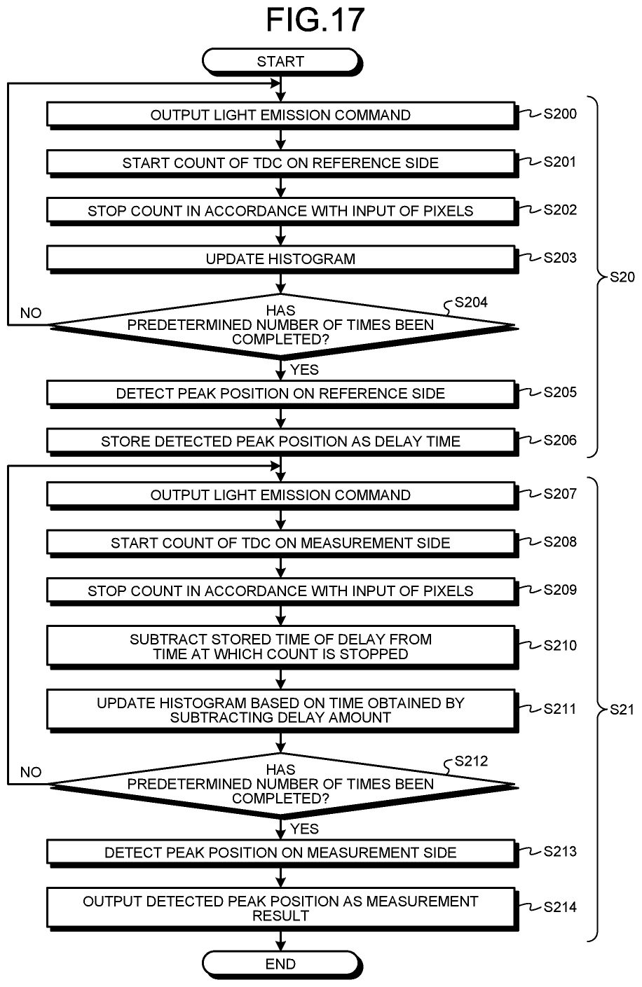

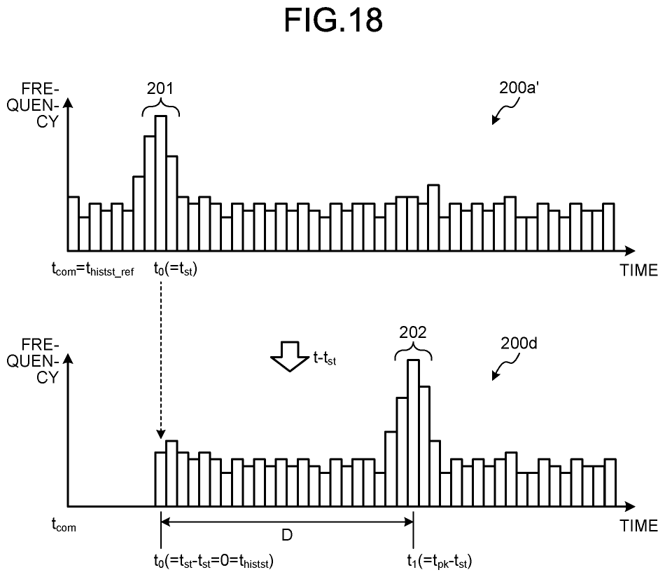

FIG. 17 is a flowchart specifically illustrating the example of the ranging process according to the second embodiment. Furthermore, FIG. 18 is a diagram illustrating an example of a histogram generated in the ranging process according to the second embodiment. Furthermore, in FIG. 18, the histogram 200a′ indicated on the upper part is associated with the histogram 200a described above with reference to FIG. 9.

In FIG. 17, the ranging process according to the second embodiment includes the process (Step S20) performed on the basis of the light receiving timing of the pixel 10 included in the reference pixel area 121 and the process (Step S21) performed on the basis of the light receiving timing of the pixel 10 included in the measurement pixel area 120. Namely, the processes performed at Step S21 is a measurement process performed in order to obtain the distance D to the object to be measured 160, whereas the process performed at Step S20 is a process performed in order to determine the starting point of the generation of the histogram in the process performed at Step S21. In the example illustrated in FIG. 17, Step S20 includes each of the processes performed at Step S200 to Step S206, whereas Step S21 includes each of the processes performed at Step S207 to Step S214.

In each of the processes indicated by the flowchart illustrated in FIG. 17, each of the processes included in Step S20, i.e., the processes performed at Step S200 to Step S206, are the same as the processes performed at Step S100 to Step S106 indicated by the flowchart illustrated in FIG. 13.

Namely, in Step S20, at Step S200, the controller 150 outputs the light emission command for allowing the LD 131 to emit light (the time t_{com} in the histogram 200a′ in FIG. 18). Furthermore, here, it is assumed that each time is obtained on the basis of the time t_{com} that is defined as a starting point. The LDD 130 drives the LD 131 in accordance with the light emission command. The LD 131 emits light, in accordance with the driving, at the time tₛₜ as the light emission timing. At subsequent Step S201, the controller 150 outputs the time count start command start to the TDC 133ref associated with the pixel 10 included in the reference pixel area 121.

The TDC 133ref starts a count that is performed in accordance with the time on the basis of the time count start command start, and then, generation of the histogram 200a′ is started in the histogram generating unit 140ref (the time t_{hist_st} ref in the histogram 200a′ in FIG. 18). Furthermore, the process performed at Step S201 is performed at substantially the same time as the process at Step S200 and this state is the time t_{com}=the time t_{histst_ref}.

The TDC 133ref stops the count in accordance with the signal Vpls that is input from the pixel 10 included in the reference pixel area 121 (Step S202). The TDC 133ref delivers the clock time information indicated by the count that is stopped at Step S203 to the histogram generating unit 140ref. The histogram generating unit 140ref increments the value of the bin that is associated with the time information delivered from the TDC 133ref by 1 in the histogram stored in the memory 141ref, and then, updates the histogram (Step S203).

At subsequent Step S204, the controller 150 judges whether the processes at Step S200 to Step S203 have been ended a predetermined number of times (for example, several thousands of times to several tens of thousands of times). If the controller 150 judges that the processes have not been ended (“No” at Step S204), the controller 150 returns the process to Step S200. In contrast, if the controller 150 judges that the processes at Step S200 to Step S203 have been ended a predetermined number of times (“Yes” at Step S204), the controller 150 proceeds the process to Step S205.

At Step S205, the peak detecting unit 142ref detects the peak position of the frequency on the basis of the histogram generated from the processes performed at Step S200 to Step S204 by the histogram generating unit 140ref. The peak position detected here is the time tₛₜ of the light emission timing at which the LD 131 emits light. At subsequent Step S206, the peak detecting unit 142ref allows the peak register 143 to store the time tₛₜ that is detected at Step S205. The time tₛₜ corresponds to the time t₁₂₋₁₀ described above with reference to FIG. 10.

If the process at Step S206 is ended, the process at Step S20 has been completed, and the process proceeds to Step S21. In Step S21, at Step S207, the controller 150 outputs the light emission command for allowing the LD 131 to emit light (the time t_{com} in a histogram 200d in FIG. 18). The LDD 130 emits light at the time tₛₜ as the light emission timing in accordance with the driving.

At subsequent Step S208, the controller 150 outputs the time count start command start to each of the TDCs 133₁, 133₂, 133₃, and . . . that are associated with the respective pixels 10 included in the measurement pixel area 120. The time count start command start is output at substantially the same time as the process of outputting the light emission command performed at Step S207. Each of the TDCs 133₁, 133₂, 133₃, and . . . stops the count in accordance with each of the signals Vpls that are input, on a one-to-one basis, from the respective pixels 10 included in the measurement pixel area 120 (Step S209).

The TDCs 133₁, 133₂, 133₃, and . . . outputs the time t₁₀₀, t₁₀₁, t₁₀₂, and . . . , respectively, that are the clock time information indicated by the count that is stopped at Step S209. The time t₁₀₀, t₁₀₁, t₁₀₂, and . . . that are output from the TDCs 133₁, 133₂, 133₃, and . . . , respectively, is input to the respective subtracted input ends of the subtracter 146₁, 146₂, 146₃, and . . . that are associated with, on a one-to-one basis, the TDCs 133₁, 133₂, 133₃, and . . . .

Here, the time tₛₜ that is stored in the peak register 143 is input to each of the subtraction input ends of the subtracter 146₁, 146₂, 146₃, and . . . . Each of the subtracter 146₁, 146₂, 146₃, and . . . performs a subtraction process of subtracting the time tₛₜ that is input to the associated subtraction input ends from the respective time t₁₀₀, t₁₀₁, t₁₀₂, and . . . that are input to the respective subtracted input ends (Step S210). Each of the subtracter 146₁, 146₂, 146₃, and . . . outputs the time (t₁₀₀−tₛₜ), the time (t₁₀₁−tₛₜ), and the time (t₁₀₂−tₛₜ), respectively, that are the respective subtraction results. The time (t₁₁₀−tₛₜ), the time (t₁₀₁−tₛₜ), and the time (t₁₀₂−tₛₜ) are supplied to the histogram generating units 140₁, 140₂, and 140₃, respectively.

At subsequent Step S211, each of the histogram generating units 140₁, 140₂, 140₃, and . . . updates the histograms on the basis of the time (t₁₀₀−tₛₜ), the time (t₁₀₁−tₛₜ), and the time (t₁₀₂−tₛₜ). Namely, each of the histogram generating units 140₁, 140₂, 140₃, and . . . increments the value of the bin associated with each of the time (t₁₀₀−tₛₜ), time (t₁₀₁−tₛₜ), and the time (t₁₀₁−tₛₜ) that are output from the subtracter 146₁, 146₂, 146₃, and . . . , respectively, by 1 in each of the associated histograms stored in the memory 141, and then, updates each of the histograms.

Furthermore, in FIG. 18, the time t₁₀₁, t₁₀₁, t₁₀₁, and . . . are represented by the time t.

As an example, in a case of the histogram generating unit 140₁ as an example, if the time t₁₀₀ that is output from the associated TDC 133₁ matches the time indicated by the time tₛₜ, the subtraction result that is output from the associated subtracter 146₁ indicates time tₛₜ−time tₛₜ=0. In contrast, the controller 150 outputs the time count start command start to the TDC 133₁ at substantially the same time as the light emission command performed at Step S20.

Even if the signal Vpls is input from the associated pixel 10 before the time tₛₜ at which an input is received by the subtraction input end of the subtracter 146₁, the TDC 133₁ stops the count and outputs the time tₓ that indicates the subject clock time. If the time tₓ is input to the subtracted input end of the subtracter 146₁, the subtraction result of the subtracter 146₁ indicates a negative value. However, at this time, if the bin that is associated with the negative value is set to be undefined in the histogram that is generated by the histogram generating unit 140₁, the subtraction result indicating the negative value is ignored by the histogram generating unit 140₁.

Therefore, the histogram generating unit 140₁ generates a histogram by setting the time tₛₜ, which is stored at Step S206 in the peak register 143, as the starting point. In this case, this corresponds to the case in which the histogram generating unit 140₁ generates the histogram 200d that is started from the time histst that is delayed by the time tₛₜ.

Furthermore, the histogram 200d is generated by each of the histogram generating units 140₁, 140₂, 140₃, and . . . regarding each of the pixels 10 included in the measurement pixel area 120 on a one-to-one basis.

At subsequent Step S212, the controller 150 judges whether the processes at Step S207 to Step S211 have been ended a predetermined number of times (for example, several thousands of times to several tens of thousands of times). If the controller 150 judges that the processes have not been ended (“No” at Step S212), the controller 150 returns the process to Step S207. In contrast, if the controller 150 judges that the processes at Step S207 to Step S211 have been ended a predetermined number of times (“Yes” at Step S212), the controller 150 proceeds the process to Step S213.

At Step S213, each of the peak detecting units 142₁, 142₂, 142₃, and . . . detects the time tₚₖ that is associated with the position of the peak 202 of the frequency on the basis of each of the histograms 200d generated by the histogram generating units 140₁, 140₂, 140₃, and . . . associated with the processes at Step S207 to Step S212. The time tₚₖ is the period of time from the time t_{com} to the peak 202. Accordingly, for example, each of the peak detecting units 142₁, 142₂, 142₃, and . . . outputs, as the measurement result of the ranging, the time (tₚₖ−tₛₜ) obtained by subtracting the time tₛₜ that is detected as the light emission timing of the LD 131 from each of the time tₚₖ acquired at Step S214.

Each of the time (tₚₖ−tₛₜ) output from the corresponding peak detecting units 142₁, 142₂, 142₃, and . . . is supplied to the arithmetic unit 145. The arithmetic unit 145 calculates each of the distances D associated with the corresponding pixels 10 included in the measurement pixel area 120 by using the time [0] as the time t₀ represented in Equation (1) described above and using each of the time (tₚₖ−tₛₜ) as the time t₁ represented in Equation (1) described above.

In this way, in the second embodiment, the time tₛₜ at which the LD 131 emits light is measured on the basis of the signal Vpls that is output from the pixel 10 included in the reference pixel area 121. Then, in the ranging process performed on the basis of the signal Vpls that is output from each of the pixels 10 included in the measurement pixel area 120, a histogram is generated by using the time obtained by subtracting the time tₛₜ at which the LD 131 emits light from the time tₚₖ that is based on an output of each of the pixels 10 included in the measurement pixel area 120. Accordingly, in the memory 141 that stores therein the data on the histogram associated with each of the pixels 10 included in the measurement pixel area 120, there is no need to store the data obtained in a period of time between the time t_{com} and the time tₛₜ, and it is thus possible to reduce the capacity of the memory 141.

Furthermore, in also the ranging apparatus 1b according to the second embodiment, the example that is described with reference to FIG. 15 and in which the ranging process is performed in units of frames is applicable in a similar manner.

### Third Embodiment

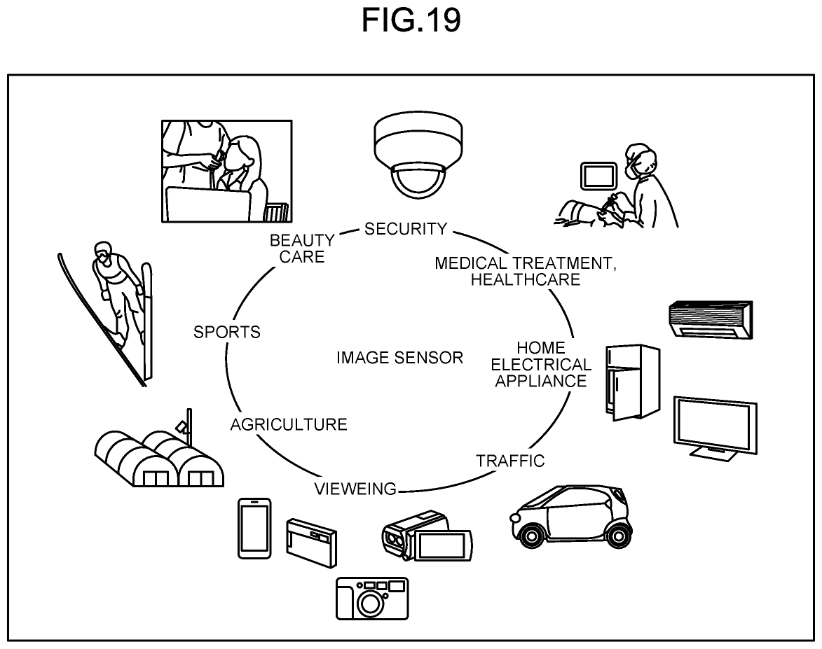

In the following, as a third embodiment according to the present disclosure, an example of application of the first embodiment and the second embodiment according to the present disclosure will be described. FIG. 19 is a diagram illustrating a use example in which the ranging apparatus 1a according to the first embodiment described above and the ranging apparatus 1b according to the second embodiment described above is used in the third embodiment.

The ranging apparatuses 1a and 1b described above are applicable to various cases in which, for example, light, such as visible light, infrared light, ultraviolet light, and X-ray, is sensed as described below.
Devices, such as a digital camera and a mobile phone with a camera function, which capture images to be provided for viewing.
Devices, such as an on-vehicle sensor that captures images of front, back, surroundings, and inside of a vehicle, a monitoring camera that monitors running vehicles and roads, and a ranging sensor that performs ranging a distance between vehicles, which are used for traffic to ensure safety driving, such as automatic stop, or to recognize a state of a driver.
Devices that are used for home electrical appliance, such as TV, a refrigerator, and an air conditioner, for capturing an image of a gesture of a user and operating devices in accordance with the gesture.
Devices, such as an endoscope and a device that captures an image of blood vessels by receiving infrared light, which are used for medical treatment and healthcare.
Devices, such as an anti-crime monitoring camera and a camera for person authentication, which are used for security.
Devices, such as a skin measurement apparatus that captures an image of skin and a microscope that captures an image of scalp, which are used for beauty care.
Devices, such as an action camera for sports and a wearable camera, which are used for sports.
Devices, such as a camera for monitoring a state of fields and crops, which are used for agriculture.

[Additional Application Example of Technique According to Present Disclosure] (Example of Application to Movable Body)

The technique according to the present disclosure may further be applied to a device that is mounted on various movable bodies, such as a vehicle, an electric vehicle, a hybrid electric vehicle, an automatic two-wheel vehicle, a bicycle, a personal mobility, an airplane, a drone, boats and ships, and a robot.

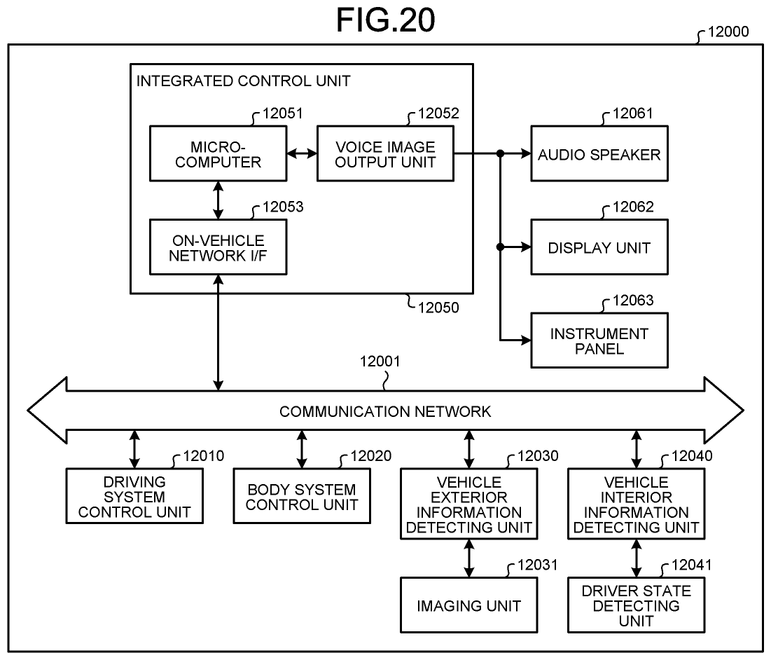

FIG. 20 is a block diagram illustrating a schematic configuration example of a vehicle control system that is an example of a movable body control system to which the technique according to the present disclosure is applicable.

A vehicle control system 12000 includes a plurality of electronic control units that are connected to each another via a communication network 12001. In the example illustrated in FIG. 20, the vehicle control system 12000 includes a driving system control unit 12010, a body system control unit 12020, a vehicle exterior information detecting unit 12030, a vehicle interior information detecting unit 12040, and an integrated control unit 12050. Furthermore, as a functional configuration of the integrated control unit 12050, a microcomputer 12051, a voice image output unit 12052, and an on-vehicle network interface (I/F) 12053 are illustrated.

The driving system control unit 12010 controls operation of devices related to a driving system of a vehicle in accordance with various programs. For example, the driving system control unit 12010 functions as a control device for a driving force generation device, such as an internal combustion engine or a driving motor, that generates a driving force of the vehicle, a driving force transmission mechanism for transmitting the driving force to wheels, a steering mechanism for adjusting a rudder angle of the vehicle, and a braking device that generates a braking force of the vehicle.

The body system control unit 12020 controls operation of various devices mounted on a vehicle body in accordance with various programs. For example, the body system control unit 12020 functions as a control device for a keyless entry system, a smart key system, a power window device, and various lamps, such as a head lamp, a back lamp, a brake lamp, a direction indicator, and a fog lamp. In this case, radio waves transmitted from a mobile terminal that is used as a substitute for a key or signals from various switches may be input to the body system control unit 12020. The body system control unit 12020 receives input of the radio waves or the signals, and controls a door lock device, a power window device, lamps, and the like of the vehicle.

A vehicle exterior information detecting unit 12030 detects information on the outside of the vehicle on which the vehicle control system 12000 is mounted. For example, an imaging unit 12031 is connected to the vehicle exterior information detecting unit 12030. The vehicle exterior information detecting unit 12030 allows the imaging unit 12031 to capture an image of the outside of the vehicle, and receives the captured image. The vehicle exterior information detecting unit 12030 may perform an object detection process or a distance detection process on a person, a vehicle, an obstacle, a sign, or characters on a road, on the basis of the received image. For example, the vehicle exterior information detecting unit 12030 performs image processing on the received image, and performs the object detection process or the distance detection process on the basis of a result of the image processing.

The imaging unit 12031 is an optical sensor that receives light and outputs an electrical signal corresponding to intensity of the received light. The imaging unit 12031 is also able to output the electrical signal as an image or information on a measured distance. Furthermore, the light that is received by the imaging unit 12031 may also be visible light or non-visible light, such as infrared light.

The vehicle interior information detecting unit 12040 detects information on the inside of the vehicle. For example, a driver state detecting unit 12041 that detects a state of a driver is connected to the vehicle interior information detecting unit 12040. The driver state detecting unit 12041 includes a camera that captures an image of the driver for example, and the vehicle interior information detecting unit 12040 may also calculate a degree of fatigue or a degree of concentration of the driver or may also determine whether the driver is sleeping on the basis of detection information that is input from the driver state detecting unit 12041.

The microcomputer 12051 is able to calculate a control target value of the driving force generation device, the steering mechanism, or the braking device on the basis of the information on the outside or the inside of the vehicle that is acquired by the vehicle exterior information detecting unit 12030 or the vehicle interior information detecting unit 12040, and issue a control command to the driving system control unit 12010. For example, the microcomputer 12051 is able to perform cooperation control to realize an advance driver assistance system (ADAS) function including vehicle crash avoidance, vehicle impact relaxation, following traveling on the basis of an inter-vehicular distance, vehicle crash warning, or vehicle lane deviation warning.

Furthermore, the microcomputer 12051 is able to perform cooperation control aiming at automatic driving in which a vehicle autonomously travels independent of operation of a driver for example, by controlling the driving force generation device, the steering mechanism, the braking device, or the like on the basis of information on the surroundings of the vehicle that is acquired by the vehicle exterior information detecting unit 12030 or the vehicle interior information detecting unit 12040.

Furthermore, the microcomputer 12051 is able to output a control command to the body system control unit 12020 on the basis of the information on the outside of the vehicle that is acquired by the vehicle exterior information detecting unit 12030. For example, the microcomputer 12051 is able to control the head lamp in accordance with a position of a preceding vehicle or an oncoming vehicle detected by the vehicle exterior information detecting unit 12030, and is able to perform cooperation control to implement anti-glare, such as switching from high beam to low beam.

The voice image output unit 12052 transmits an output signal of at least one of voice and an image to an output device capable of visually or aurally information to a passenger of the vehicle or to the outside of the vehicle. In the example in FIG. 20, an audio speaker 12061, a display unit 12062, and an instrument panel 12063 are illustrated as examples of the output device. The display unit 12062 may also include, for example, at least one of an on-board display and a head-up display.

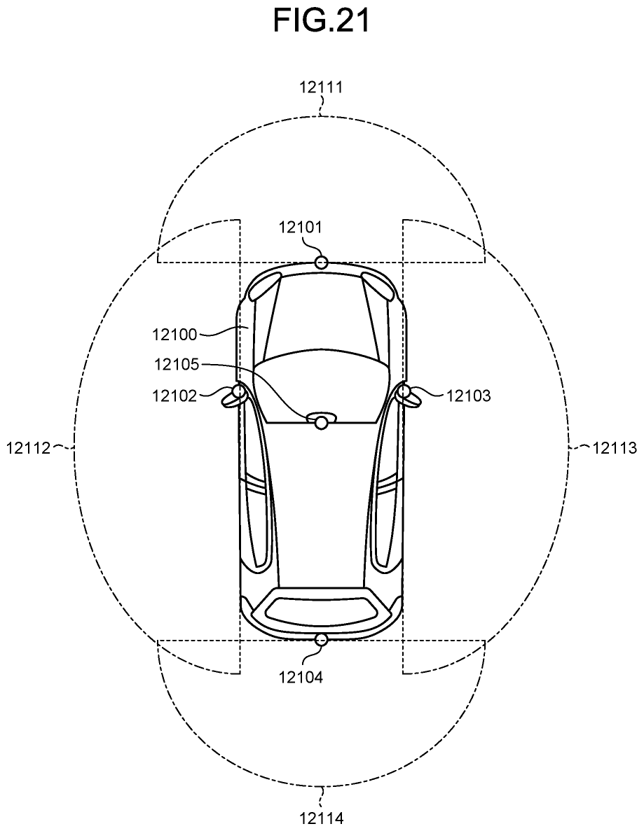

FIG. 21 is a diagram illustrating an example of installation positions of the imaging unit 12031. In FIG. 21, a vehicle 12100 includes, as the imaging unit 12031, imaging units 12101, 12102, 12103, 12104, and 12105.

The imaging units 12101, 12102, 12103, 12104, and 12105 are arranged at positions of, for example, a front nose, side mirrors, a rear bumper, a back door, or an upper part of a windshield inside the vehicle, and the like of the vehicle 12100. The imaging unit 12101 mounted on the front nose and the imaging unit 12105 mounted on the upper part of the windshield inside the vehicle mainly acquire images of the front of the vehicle 12100. The imaging units 12102 and 12103 mounted on the side mirrors mainly acquire images of the sides of the vehicle 12100. The imaging unit 12104 mounted on the rear bumper or the back door mainly acquires an image of the rear of the vehicle 12100. The front image acquired by the imaging units 12101 and 12105 is mainly used to detect a preceding vehicle, a pedestrian, an obstacle, a traffic signal, a traffic sign, a traffic lane, or the like.

Furthermore, FIG. 21 illustrates an example of imaging ranges of the imaging units 12101 to 12104. An imaging range 12111 indicates an imaging range of the imaging unit 12101 arranged on the front nose, imaging ranges 12112 and 12113 indicate imaging ranges of the imaging units 12102 and 12103 arranged on the respective side mirrors, and an imaging range 12114 indicates an imaging range of the imaging unit 12104 arranged on the rear bumper or the back door. For example, by superimposing pieces of image data captured by the imaging units 12101 to 12104, a downward image of the vehicle 12100 viewed from above is obtained.

At least one of the imaging units 12101 to 12104 may also have a function to acquire distance information. For example, at least one of the imaging units 12101 to 12104 may be a stereo camera including a plurality of imaging elements, or may be an imaging element including a pixel for detecting a phase difference.

For example, by obtaining a distance to each of stereoscopic objects in the imaging ranges 12111 to 12114 and obtaining a temporal change in the distance (relative speed with respect to the vehicle 12100) on the basis of the distance information obtained from the imaging units 12101 to 12104, the microcomputer 12051 is able to particularly detect, as a preceding vehicle, a stereoscopic object that is located closest to the vehicle 12100 on a road on which the vehicle 12100 travels and that travels at a predetermined speed (for example, 0 km/h or higher) in approximately the same direction as the vehicle 12100. Furthermore, the microcomputer 12051 is able to set, in advance, an inter-vehicular distance that needs to be ensured on the near side of the preceding vehicle, and perform automatic braking control (including following stop control), automatic acceleration control (including following starting control), and the like. In this way, it is possible to perform cooperation control aiming at automatic driving or the like in which running is autonomously performed independent of operation of a driver.

For example, the microcomputer 12051 is able to classify and extract stereoscopic object data related to a stereoscopic object as a two-wheel vehicle, a normal vehicle, a heavy vehicle, a pedestrian, or other stereoscopic objects, such as a power pole, on the basis of the distance information obtained from the imaging units 12101 to 12104, and use the stereoscopic object data to automatically avoid an obstacle. For example, the microcomputer 12051 identifies an obstacle around the vehicle 12100 as an obstacle that can be viewed by the driver of the vehicle 12100 or an obstacle that can hardly be viewed by the driver. Then, the microcomputer 12051 determines a crash risk indicating a degree of risk of crash with each of objects, and if the crash risk is equal to or larger than a set value and there is the possibility that crash occurs, it is possible to support driving to avoid crash by outputting an alarm to the driver via the audio speaker 12061 or the display unit 12062 or performing forcible deceleration or avoidance steering via the driving system control unit 12010.

At least one of the imaging units 12101 to 12104 may also be an infrared camera that detects infrared light. For example, the microcomputer 12051 is able to recognize a pedestrian by determining whether a pedestrian is present in the captured images of the imaging units 12101 to 12104. The pedestrian recognition described above is performed by, for example, a process of extracting feature points in the captured images of the imaging units 12101 to 12104 that serve as the infrared cameras and a process of performing pattern matching on a series of feature points representing a contour of an object to determine whether the object is a pedestrian. If the microcomputer 12051 determines that a pedestrian is present in the captured images of the imaging units 12101 to 12104 and recognizes the pedestrian, the voice image output unit 12052 causes the display unit 12062 to display a rectangular contour line for enhancing the recognized pedestrian in a superimposed manner. Furthermore, the voice image output unit 12052 may also cause the display unit 12062 to display an icon or the like that represents the pedestrian at a desired position.

In the above, an example of the vehicle control system to which the technique according to the present disclosure is applicable has been described. The technique according to the present disclosure is applicable to, for example, the imaging unit 12031 in the configuration described above. Specifically, the ranging apparatus 1a according to the first embodiment described above and the ranging apparatus 1b according to the second embodiment described above are applicable to the imaging unit 12031. By applying the technique according to the present disclosure to the imaging unit 12031, it is possible to reduce the capacity of the memory that stores therein a histogram used for ranging.

Furthermore, the effects described in this specification are only exemplified and are not limited, and other effects may also be possible.

Furthermore, the present technology can also be configured as follows.

(1) A measurement apparatus comprising:

a first pixel;

a light source;

a control unit that controls emission of light emitted from the light source by generating light emission commands that allow the light source to emit light;

a first measuring unit that measures a first time period between a first light emission command timing at which the control unit generates a first light emission command out of the light emission commands and a light emission timing at which the light source emits light in accordance with the first light emission command;

a second measuring unit that measures a second time period between a second light emission command timing at which the control unit generates a second light emission command out of the light emission commands and a time at which the light is received by the first pixel; and

a generating unit that generates a histogram on the basis of the second time period that is measured by the second measuring unit, wherein

the generating unit generates the histogram of which a starting point is a time when the first period elapses from the second light emission command.

(2) The measurement apparatus according to the above (1), wherein the generating unit generates the histogram on the basis of the time obtained by subtracting the first time period from the second time period.
(3) The measurement apparatus according to the above (1), wherein the generating unit generates the histogram of which a starting point is a time that is delayed by the first period from the second light emission command.
(4) The measurement apparatus according to any one of the above (1) to (3), wherein

the first measuring unit performs measurement of the first time period in units of frames, and

the second measuring unit further performs measurement of the second time period in the frame.

(5) The measurement apparatus according to the above (4), wherein the generating unit starts to generate the histogram in a first frame from among the frames on the basis of the first time period that is measured, by the first measuring unit, in a second frame that is located immediately before the first frame from among the frames.
(6) The measurement apparatus according to any one of the above (1) to (5), further comprising:

a second pixel; and

a waveguide unit that guides the light emitted by the light source to the second pixel, wherein

the first measuring unit measures, as the first time period, a time period between the first light emission command timing and a time at which the light emitted from the light source is received by the second pixel via the waveguide unit due to the first light emission command related to the first light emission command timing.

(7) The measurement apparatus according to the above (6), wherein the waveguide unit is a mirror that reflects light and is arranged at a position close to the light source and the second pixel such that a period of time until the light emitted from the light source is received by the second pixel via the waveguide unit is less than or equal to a predetermined period of time.
(8) A ranging apparatus comprising:

a first pixel;

a light source;

a control unit that controls emission of light emitted from the light source by generating light emission commands that allow the light source to emit light;

a first measuring unit that measures a first time period between a first light emission command timing at which the control unit generates a first light emission command out of the light emission commands and a light emission timing at which the light source emits light in accordance with the first light emission command;

a second measuring unit that measures a second time period between a second light emission command timing at which the control unit generates a second light emission command out of the light emission commands and a time at which the light is received by the first pixel;

a generating unit that generates a histogram on the basis of the second time period measured by the second measuring unit; and

an arithmetic unit that performs an arithmetic operation of calculating a distance to an object to be measured on the basis of the histogram, wherein

the generating unit generates the histogram of which a starting point is a time when the first period elapses from the second light emission command.

(9) The ranging apparatus according to the above (8), wherein the generating unit generates the histogram on the basis of the time obtained by subtracting the first time period from the second time period.
(10) The ranging apparatus according to the above (8), wherein the generating unit starts to generate the histogram by setting, as the starting point of the second light emission command timing, a timing that is delayed by the first time period.
(11) The ranging apparatus according to any one of the above (8) to (10), wherein

the first measuring unit performs measurement of the first time period in units of frames, and

the second measuring unit further performs measurement of the second time period in the frame.

(12) The ranging apparatus according to the above (11), wherein the generating unit starts to generate the histogram in a first frame from among the frames on the basis of the first time period that is measured, by the first measuring unit, in a second frame that is located immediately before the first frame from among the frames.
(13) The ranging apparatus according to any one of the above (8) to (12), further comprising:

a second pixel; and

a waveguide unit that guides the light emitted by the light source to the second pixel, wherein

the first measuring unit measures, as the first time period, a time period between the first light emission command timing the a time at which the light emitted from the light source is received by the second pixel via the waveguide unit due to the first light emission command related to the first light emission command timing.

(14) The ranging apparatus according to the above (13), wherein the waveguide unit is a mirror that reflects light and is arranged at a position close to light source and the second pixel such that a period of time until the light emitted from the light source is received by the second pixel via the waveguide unit is less than or equal to a predetermined period of time.
(15) A measurement method comprising:

a first measuring step of measuring a first time period between a first light emission command timing at which a control unit, which controls emission of light emitted from a light source by generating light emission commands that allow the light source to emit light, generates a first light emission command out of the light emission commands and a light emission timing at which the light source emits light in accordance with the first light emission command;

a second measuring step of measuring a second time period between a second light emission command timing at which the control unit generates a second light emission command out of the light emission commands and a time at which the light is received by a first pixel; and

a generating step of generating a histogram on the basis of the second time period that is measured at the second measuring step, wherein

the generating step includes generating the histogram of which a starting point is a time when the first period elapses from the second light emission command.

### REFERENCE SIGNS LIST

1, 1a, 1b ranging apparatus
2 light source unit
10 pixel
100 pixel array unit
120 measurement pixel area
121 reference pixel area
122 mirror
130 LDD
131 LD
133, 133₁, 133₂, 133₃, 133ref TDC
140₁, 140₂, 140₃, 140ref histogram generating unit
141, 141ref memory
142₁, 142₂, 142₃, 142ref peak detecting unit
143 peak register
144 delay unit
145 arithmetic unit
150 controller
200a, 200a′, 200b, 200c histogram
201, 202 peak

1. A measurement apparatus comprising:
a first pixel;
a light source;
a control unit that controls emission of light emitted from the light source by generating light emission commands that allow the light source to emit light;
a first measuring unit that measures a first time period between a first light emission command timing at which the control unit generates a first light emission command out of the light emission commands and a light emission timing at which the light source emits light in accordance with the first light emission command;
a second measuring unit that measures a second time period between a second light emission command timing at which the control unit generates a second light emission command out of the light emission commands and a time at which the light is received by the first pixel; and
a generating unit that generates a histogram on the basis of the second time period that is measured by the second measuring unit, wherein
the generating unit generates the histogram of which a starting point is a time when the first period elapses from the second light emission command.

2. The measurement apparatus according claim 1, wherein the generating unit generates the histogram on the basis of the time obtained by subtracting the first time period from the second time period.

3. The measurement apparatus according to claim 1, wherein the generating unit generates the histogram of which a starting point is a time that is delayed by the first period from the second light emission command.

4. The measurement apparatus according to claim 1, wherein
the first measuring unit performs measurement of the first time period in units of frames, and
the second measuring unit further performs measurement of the second time period in the frame.

5. The measurement apparatus according to claim 4, wherein the generating unit starts to generate the histogram in a first frame from among the frames on the basis of the first time period that is measured, by the first measuring unit, in a second frame that is located immediately before the first frame from among the frames.

6. The measurement apparatus according to claim 1, further comprising:
a second pixel; and
a waveguide unit that guides the light emitted by the light source to the second pixel, wherein
the first measuring unit measures, as the first time period, a time period between the first light emission command timing and a time at which the light emitted from the light source is received by the second pixel via the waveguide unit due to the first light emission command related to the first light emission command timing.

7. The measurement apparatus according to claim 6, wherein the waveguide unit is a mirror that reflects light and is arranged at a position close to the light source and the second pixel such that a period of time until the light emitted from the light source is received by the second pixel via the waveguide unit is less than or equal to a predetermined period of time.

8. A ranging apparatus comprising:
a first pixel;
a light source;
a control unit that controls emission of light emitted from the light source by generating light emission commands that allow the light source to emit light;
a first measuring unit that measures a first time period between a first light emission command timing at which the control unit generates a first light emission command out of the light emission commands and a light emission timing at which the light source emits light in accordance with the first light emission command;
a second measuring unit that measures a second time period between a second light emission command timing at which the control unit generates a second light emission command out of the light emission commands and a time at which the light is received by the first pixel;
a generating unit that generates a histogram on the basis of the second time period measured by the second measuring unit; and
an arithmetic unit that performs an arithmetic operation of calculating a distance to an object to be measured on the basis of the histogram, wherein
the generating unit generates the histogram of which a starting point is a time when the first period elapses from the second light emission command.

9. The ranging apparatus according to claim 8, wherein the generating unit generates the histogram on the basis of the time obtained by subtracting the first time period from the second time period.

10. The ranging apparatus according to claim 8, wherein the generating unit generates a histogram of which a starting point is a time that is delayed by the first period from the second light emission command.

11. The ranging apparatus according to claim 8, wherein
the first measuring unit performs measurement of the first time period in units of frames, and
the second measuring unit further performs measurement of the second time period in the frame.

12. The ranging apparatus according to claim 11, wherein the generating unit starts to generate the histogram in a first frame from among the frames on the basis of the first time period that is measured, by the first measuring unit, in a second frame that is located immediately before the first frame from among the frames.

13. The ranging apparatus according to claim 8, further comprising:
a second pixel; and
a waveguide unit that guides the light emitted by the light source to the second pixel, wherein
the first measuring unit measures, as the first time period, a time period between the first light emission command timing the a time at which the light emitted from the light source is received by the second pixel via the waveguide unit due to the first light emission command related to the first light emission command timing.

14. The ranging apparatus according to claim 13, wherein the waveguide unit is a mirror that reflects light and is arranged at a position close to light source and the second pixel such that a period of time until the light emitted from the light source is received by the second pixel via the waveguide unit is less than or equal to a predetermined period of time.

15. A measurement method comprising:
a first measuring step of measuring a first time period between a first light emission command timing at which a control unit, which controls emission of light emitted from a light source by generating light emission commands that allow the light source to emit light, generates a first light emission command out of the light emission commands and a light emission timing at which the light source emits light in accordance with the first light emission command;
a second measuring step of measuring a second time period between a second light emission command timing at which the control unit generates a second light emission command out of the light emission commands and a time at which the light is received by a first pixel; and
a generating step of generating a histogram on the basis of the second time period that is measured at the second measuring step, wherein
the generating step includes generating the histogram of which a starting point is a time when the first period elapses from the second light emission command.
